(19) United States
(12) Patent Application Publication
(10) Pub. No.: US 2026/0255249 A1
(43) Pub. Date: Aug. 27, 2026

(54) INDICATION OF CAPABILITY OF PROCESSING A RADIO RESOURCE CONTROL CONFIGURATION FOR HANDOVER

(71) Applicant: Nokia Technologies Oy, Espoo (FI)

(72) Inventors: Jani-Pekka KAINULAINEN, Cambridge (GB); Xin ZHANG, Munich (DE); Lars DALSGAARD, Oulu (FI)

(21) Appl. No.: 19/199,247

(22) PCT Filed: Oct. 23, 2023
(86) PCT No.: PCT/EP2023/079473

§ 371 Date: May 5, 2025

(30) Foreign Application Priority Data
Nov. 14, 2022 (FI) 20226022

(51) Int. Cl. H04W 36/32; H04W 36/00

(52) U.S. Cl. CPC H04W 36/324; H04W 36/0058

(57) ABSTRACT

Various example embodiments relate to cell switch in a cellular communication network. receiving, by a user equipment, a radio resource control (RRC) reconfiguration message associated with a Layer 1/Layer 2 (L1/L2) triggered mobility (LTM) procedure; determining whether the UE is able to pre-process at least part of the RRC reconfiguration message related to LTM before reception of a cell switch command for performing a cell switch; performing preprocessing of at least part of a LTM related part of the received RRC reconfiguration message, and transmitting, towards a network node of a radio access network the user equipment is connected to, a message including an indication related to the preprocessed part of LTM related part of the radio resource control reconfiguration message before the reception of the cell switch command.

### TECHNICAL FIELD

Various example embodiments generally relate to the field of cellular communication networks. Some example embodiments relate to signalling an indication of a capability of a user equipment to process a radio resource control configuration for a handover.

### BACKGROUND

Wireless communication networks may be implemented as a cellular network, where user equipment (UE) are served by cells of the network. When a UE moves within the network, the serving cell may be changed in order to maintain connectivity with the UE, for example in accordance with Layer 1/Layer 2 (L1/L2) triggered mobility (LTM) procedures of 3GPP (3^{rd} Generation Partnership Project) radio access networks (RAN).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable reducing handover or cell switch delay. This and other benefits may be achieved by the features of the independent claims. Further example embodiments are provided in the dependent claims, the description, and the drawings.

According to a first aspect, a method is disclosed. The method may comprise: receiving, by a user equipment, a radio resource control (RRC) reconfiguration message associated with a Layer 1/Layer 2 (L1/L2) triggered mobility (LTM) procedure; determining whether the user equipment is able to pre-process at least part of the radio resource control reconfiguration message related to Layer 1/Layer 2 (L1/L2) triggered mobility (LTM) before reception of a cell switch command for performing a cell switch; performing pre-processing of at least part of a Layer 1/Layer 2 (L1/L2) triggered mobility (LTM) related part of the received RRC reconfiguration message; and transmitting, towards a network node of a radio access network the user equipment is connected to, a message including an indication related to the pre-processed part of the Layer 1/Layer 2 (L1/L2) triggered mobility (LTM) related part of the radio resource control reconfiguration message before the reception of the cell switch command.

According to an example embodiment of the first aspect, the network node is a central node of the radio access network and the message transmitted to the central node is an RRC reconfiguration complete message including an LTM indication indicating a status of the pre-processing of LTM preparation operations.

According to an example embodiment of the first aspect, the network node is a distributed node of the radio access network and the message transmitted to the distributed node is a L2 (Layer 2) message.

According to an example embodiment of the first aspect, the L2 message comprises a medium access control (MAC) control element (CE) message including an LTM indication indicating a status of the pre-processing of LTM preparation operations.

According to an example embodiment of the first aspect, the network node is a distributed node of the radio access network and the message transmitted to the distributed node is a L1 measurement report message including an LTM indication indicating a status of the pre-processing of LTM preparation operations.

According to an example embodiment of the second aspect, the LTM indication indicating the status of the pre-processing of LTM preparation operations comprises an indication whether at least one of Abstract Syntax Notation One (ASN.1) validation and LTM RRC configuration evaluation related operations has been performed.

According to an example embodiment of the first aspect, the indication related to the pre-processed part includes an indication related to a remaining LTM execution time delay.

According to a second aspect, a method is disclosed. The method may comprise: receiving, by a user equipment, a radio resource control (RRC) reconfiguration message associated with a Layer 1/Layer 2 (L1/L2) triggered mobility (LTM) procedure and including an instruction to pre-process at least part of a Layer 1/Layer 2 (L1/L2) triggered mobility (LTM) related part of the received RRC message, determining whether the user equipment is able to pre-process the indicated at least part of the radio resource control reconfiguration message related to Layer 1/Layer 2 (L1/L2) triggered mobility (LTM) before reception of a cell switch command for performing the cell switch, and performing pre-processing of at least part of the indicated the Layer 1/Layer 2 (L1/L2) triggered mobility (LTM) related part of the received RRC message.

According to an example embodiment of the second aspect, the method may comprise: transmitting, towards a network node of a radio access network the user equipment is connected to, a L1 measurement report message after the performed pre-processing is concluded.

According to an example embodiment of the second aspect, the method may comprise: in response to receiving a L2 message including the cell switch command, processing a non-pre-processed Layer 1/Layer 2 (L1/L2) triggered mobility (LTM) related part of the received RRC reconfiguration message, and extracting target cell information to switch to from the cell switch command, and performing a random access procedure towards the target cell.

According to an example embodiment of the second aspect, the L2 message comprises a medium access control (MAC) control element (CE) message.

According to a third aspect, a method is disclosed: The method may comprise: establishing, by a user equipment (UE), a connection towards a network node of a radio access network; transmitting, by the UE, UE capability indication towards the network node related to capability to support Layer 1/Layer 2 (L1/L2) triggered mobility (LTM) operation and related to support of pre-processing at least part of a radio resource control reconfiguration message related to Layer 1/Layer 2 (L1/L2) triggered mobility (LTM) before reception of a cell switch command for performing a cell switch; receiving, by the user equipment, a radio resource control (RRC) reconfiguration message associated with a Layer 1/Layer 2 (L1/L2) triggered mobility (LTM) procedure; and performing pre-processing of at least part of a Layer 1/Layer 2 (L1/L2) triggered mobility (LTM) related part of the received RRC message.

According to an example embodiment of the third aspect, the UE capability indication is transmitted to the network node during or after establishment of the connection towards the network node.

According to an example embodiment of the third aspect, the UE capability indication is transmitted to the network node before performing preparation for LTM, or, wherein the UE capability indication is transmitted to the network node before or together with a L3 measurement report.

According to an example embodiment of the third aspect, the pre-processing of the at least part of the Layer 1/Layer 2 (L1/L2) triggered mobility (LTM) related part of the received RRC reconfiguration message comprises pre-processing at least one of Abstract Syntax Notation One (ASN.1) validation and LTM RRC configuration evaluation related operations.

According to a fourth aspect, a method is disclosed. The method may comprise: transmitting, by a network node of a radio access network, a radio resource control (RRC) reconfiguration message associated with a Layer 1/Layer 2 (L1/L2) triggered mobility (LTM) procedure to a user equipment; receiving, from a user equipment connected to the radio access network, a message including an indication related to the pre-processed part of the Layer 1/Layer 2 (L1/L2) triggered mobility (LTM) related part of the radio resource control reconfiguration message before the reception of the cell switch command; and configuring at least one delay value of the Layer 1/Layer 2 (L1/L2) triggered mobility (LTM) procedure for the user equipment based on the indication related to the pre-processed part of the Layer 1/Layer 2 (L1/L2) triggered mobility (LTM) related part of the radio resource control reconfiguration message by the user equipment.

According to an example embodiment of the fourth aspect, the network node is a central node of the radio access network and the message received by the central node is an RRC reconfiguration complete message including an LTM indication indicating a status of the pre-processing of LTM preparation operations.

According to an example embodiment of the fourth aspect, the network node is a distributed node of the radio access network and the message received by the distributed node is a L2 message including an LTM indication indicating a status of the pre-processing of LTM preparation operations.

According to an example embodiment of the fourth aspect, the L2 message comprises a medium access control (MAC) control element (CE) message.

According to an example embodiment of the fourth aspect, the network node is a distributed node of the radio access network and the message received by the distributed node is a L1 measurement report message including an LTM indication indicating a status of the pre-processing of LTM preparation operations.

According to an example embodiment of the fourth aspect, the LTM indication indicating the status of the pre-processing of LTM preparation operations comprises an indication of whether at least one of Abstract Syntax Notation One (ASN.1) validation and LTM RRC configuration evaluation related operations has been performed.

According to an example embodiment of the fourth aspect, the indication related to the pre-processed part includes an indication related to a remaining LTM execution time delay.

According to a fifth aspect, a method is disclosed. The method may comprise: transmitting, by a network node to a user equipment, a radio resource control (RRC) reconfiguration message associated with a Layer 1/Layer 2 (L1/L2) triggered mobility (LTM) procedure and including an instruction to pre-process at least part of a Layer 1/Layer 2 (L1/L2) triggered mobility (LTM) related part of a RRC message.

According to a sixth aspect, a method is disclosed. The method may comprise: establishing, by a network node of a radio access network, a connection with a user equipment (UE); receiving, from the UE, UE capability indication related to a capability to support Layer 1/Layer 2 (L1/L2) triggered mobility (LTM) procedure and related to support of pre-processing at least part of a radio resource control reconfiguration message related to Layer 1/Layer 2 (L1/L2) triggered mobility (LTM) before reception of a cell switch command for performing a cell switch; and configuring at least one delay value of the Layer 1/Layer 2 (L1/L2) triggered mobility (LTM) procedure for user equipment based on the indication related to the pre-processed part of the Layer 1/Layer 2 (L1/L2) triggered mobility (LTM) related part of the radio resource control reconfiguration message by the user equipment.

According to an example embodiment of the sixth aspect, the UE capability indication is received during or after establishment of the connection with the UE.

According to an example embodiment of the sixth aspect, the UE capability indication is received before or together with a L3 measurement report:

According to an example embodiment of any of the first to sixth aspects, the pre-processing of the at least part of the Layer 1/Layer 2 (L1/L2) triggered mobility (LTM) related part of the received RRC reconfiguration message comprises pre-processing at least one of Abstract Syntax Notation One (ASN.1) validation and LTM RRC configuration evaluation related operations.

According to a seventh aspect, an apparatus is disclosed. The apparatus may comprise means for performing a method according to any of the first to sixth aspects, or any example embodiment thereof.

According to an eighth aspect, a computer program or a computer program product is disclosed. The computer program or computer program product may comprise instructions, which when executed by an apparatus, cause the apparatus perform the method according to any of the first to sixth aspects, or any example embodiment thereof.

According to a ninth aspect, an apparatus is disclosed. The apparatus may comprise at least one processor; and at least one memory storing instructions that, when executed by the at least one processor, cause the apparatus at least to: receive, by a user equipment, a radio resource control (RRC) reconfiguration message associated with a Layer 1/Layer 2 (L1/L2) triggered mobility (LTM) procedure; determining whether the user equipment is able to pre-process at least part of the radio resource control reconfiguration message related to Layer 1/Layer 2 (L1/L2) triggered mobility (LTM) before reception of a cell switch command for performing a cell switch; perform pre-processing of at least part of a Layer 1/Layer 2 (L1/L2) triggered mobility (LTM) related part of the received RRC reconfiguration message; and transmit, towards a network node of a radio access network the user equipment is connected to, a message including an indication related to the pre-processed part of the Layer 1/Layer 2 (L1/L2) triggered mobility (LTM) related part of the radio resource control reconfiguration message before the reception of the cell switch command.

According to an example embodiment of the ninth aspect, the network node is a central node of the radio access network and the message transmitted to the central node is an RRC reconfiguration complete message including an LTM indication indicating a status of the pre-processing of LTM preparation operations.

According to an example embodiment of the ninth aspect, the network node is a distributed node of the radio access network and the message transmitted to the distributed node is a L2 (Layer 2) message.

According to an example embodiment of the ninth aspect, the L2 message comprises a medium access control (MAC) control element (CE) message including an LTM indication indicating a status of the pre-processing of LTM preparation operations.

According to an example embodiment of the ninth aspect, the network node is a distributed node of the radio access network and the message transmitted to the distributed node is a L1 measurement report message including an LTM indication indicating a status of the pre-processing of LTM preparation operations.

According to an example embodiment of the second aspect, the LTM indication indicating the status of the pre-processing of LTM preparation operations comprises an indication whether at least one of Abstract Syntax Notation One (ASN.1) validation and LTM RRC configuration evaluation related operations has been performed.

According to an example embodiment of the ninth aspect, the indication related to the pre-processed part includes an indication related to a remaining LTM execution time delay.

According to a tenth aspect, an apparatus is disclosed. The apparatus may comprise at least one processor; and at least one memory storing instructions that, when executed by the at least one processor, cause the apparatus at least to: receive, by a user equipment, a radio resource control (RRC) reconfiguration message associated with a Layer 1/Layer 2 (L1/L2) triggered mobility (LTM) procedure and including an instruction to pre-process at least part of a Layer 1/Layer 2 (L1/L2) triggered mobility (LTM) related part of the received RRC message; determine whether the user equipment is able to pre-process the indicated at least part of the radio resource control reconfiguration message related to Layer 1/Layer 2 (L1/L2) triggered mobility (LTM) before reception of a cell switch command for performing the cell switch; and perform pre-processing of at least part of the indicated the Layer 1/Layer 2 (L1/L2) triggered mobility (LTM) related part of the received RRC message.

According to an example embodiment of the tenth aspect, the instructions are configured to, when executed by the at least one processor, cause the apparatus to: transmit, towards a network node of a radio access network the user equipment is connected to, a L1 measurement report message after the performed pre-processing is concluded.

According to an example embodiment of the tenth aspect, the instructions are configured to, when executed by the at least one processor, cause the apparatus to: process a non-pre-processed Layer 1/Layer 2 (L1/L2) triggered mobility (LTM) related part of the received RRC reconfiguration message in response to receiving a L2 message including the cell switch command; extract target cell information to switch to from the cell switch command; and perform a random access procedure towards the target cell.

According to an example embodiment of the tenth aspect, the L2 message comprises a medium access control (MAC) control element (CE) message.

According to an eleventh aspect, an apparatus is disclosed. The apparatus may comprise at least one processor; and at least one memory storing instructions that, when executed by the at least one processor, cause the apparatus at least to: establish, by a user equipment (UE), a connection towards a network node of a radio access network; transmit, by the UE, UE capability indication towards the network node related to capability to support Layer 1/Layer 2 (L1/L2) triggered mobility (LTM) operation and related to support of pre-processing at least part of a radio resource control reconfiguration message related to Layer 1/Layer 2 (L1/L2) triggered mobility (LTM) before reception of a cell switch command for performing a cell switch; receive, by the user equipment, a radio resource control (RRC) reconfiguration message associated with a Layer 1/Layer 2 (L1/L2) triggered mobility (LTM) procedure; and performing pre-processing of at least part of a Layer 1/Layer 2 (L1/L2) triggered mobility (LTM) related part of the received RRC message.

According to an example embodiment of the eleventh aspect, the instructions are configured to, when executed by the at least one processor, cause the apparatus to: transmit the UE capability indication to the network node during or after establishment of the connection towards the network node.

According to an example embodiment of the eleventh aspect, the instructions are configured to, when executed by the at least one processor, cause the apparatus to: transmit the UE capability indication to the network node before performing preparation for LTM, or, transmit the UE capability indication to the network node before or together with a L3 measurement report.

According to an example embodiment of the eleventh aspect, the pre-processing of the at least part of the Layer 1/Layer 2 (L1/L2) triggered mobility (LTM) related part of the received RRC reconfiguration message comprises pre-processing at least one of Abstract Syntax Notation One (ASN.1) validation and LTM RRC configuration evaluation related operations.

According to a twelfth aspect, an apparatus is disclosed. The apparatus may comprise at least one processor; and at least one memory storing instructions that, when executed by the at least one processor, cause the apparatus at least to: transmit, by a network node of a radio access network, a radio resource control (RRC) reconfiguration message associated with a Layer 1/Layer 2 (L1/L2) triggered mobility (LTM) procedure to a user equipment; receive, from a user equipment connected to the radio access network, a message including an indication related to the pre-processed part of the Layer 1/Layer 2 (L1/L2) triggered mobility (LTM) related part of the radio resource control reconfiguration message before the reception of the cell switch command; and configure at least one delay value of the Layer 1/Layer 2 (L1/L2) triggered mobility (LTM) procedure for the user equipment based on the indication related to the pre-processed part of the Layer 1/Layer 2 (L1/L2) triggered mobility (LTM) related part of the radio resource control reconfiguration message by the user equipment.

According to an example embodiment of the twelfth aspect, the network node is a central node of the radio access network and the message received by the central node is an RRC reconfiguration complete message including an LTM indication indicating a status of the pre-processing of LTM preparation operations.

According to an example embodiment of the twelfth aspect, the network node is a distributed node of the radio access network and the message received by the distributed node is a L2 message including an LTM indication indicating a status of the pre-processing of LTM preparation operations.

According to an example embodiment of the twelfth aspect, the L2 message comprises a medium access control (MAC) control element (CE) message.

According to an example embodiment of the twelfth aspect, the network node is a distributed node of the radio access network and the message received by the distributed node is a L1 measurement report message including an LTM indication indicating a status of the pre-processing of LTM preparation operations.

According to an example embodiment of the twelfth aspect, the LTM indication indicating the status of the pre-processing of LTM preparation operations comprises an indication of whether at least one of Abstract Syntax Notation One (ASN.1) validation and LTM RRC configuration evaluation related operations has been performed.

According to an example embodiment of the twelfth aspect, the indication related to the pre-processed part includes an indication related to a remaining LTM execution time delay.

According to a thirteenth aspect, an apparatus is disclosed. The apparatus may comprise at least one processor; and at least one memory storing instructions that, when executed by the at least one processor, cause the apparatus at least to: transmit, by a network node to a user equipment, a radio resource control (RRC) reconfiguration message associated with a Layer 1/Layer 2 (L1/L2) triggered mobility (LTM) procedure and including an instruction to pre-process at least part of a Layer 1/Layer 2 (L1/L2) triggered mobility (LTM) related part of a RRC message.

According to a fourteenth aspect, an apparatus is disclosed. The apparatus may comprise at least one processor; and at least one memory storing instructions that, when executed by the at least one processor, cause the apparatus at least to: establish, by a network node of a radio access network, a connection with a user equipment (UE); receive, from the UE, UE capability indication related to a capability to support Layer 1/Layer 2 (L1/L2) triggered mobility (LTM) procedure and related to support of pre-processing at least part of a radio resource control reconfiguration message related to Layer 1/Layer 2 (L1/L2) triggered mobility (LTM) before reception of a cell switch command for performing a cell switch; and configure at least one delay value of the Layer 1/Layer 2 (L1/L2) triggered mobility (LTM) procedure for user equipment based on the indication related to the pre-processed part of the Layer 1/Layer 2 (L1/L2) triggered mobility (LTM) related part of the radio resource control reconfiguration message by the user equipment.

According to an example embodiment of the fourteenth aspect, the instructions are configured to, when executed by the at least one processor, cause the apparatus to: receive the UE capability indication during or after establishment of the connection with the UE.

According to an example embodiment of the fourteenth aspect, the instructions are configured to, when executed by the at least one processor, cause the apparatus to: receive the capability indication before or together with a L3 measurement report:

According to an example embodiment of any of the ninth to fourteenth aspects, the pre-processing of the at least part of the Layer 1/Layer 2 (L1/L2) triggered mobility (LTM) related part of the received RRC reconfiguration message comprises pre-processing at least one of Abstract Syntax Notation One (ASN.1) validation and LTM RRC configuration evaluation related operations.

According to a fifteenth aspect, a (non-transitory) computer readable medium is disclosed. The (non-transitory) computer readable medium may comprise program instructions that, when executed by an apparatus, cause the apparatus to perform a method according to any of the first to sixth aspects, or any example embodiment thereof.

Example embodiments of the present disclosure can thus provide apparatuses, methods, computer programs, computer program products, or computer readable media for enabling a handover or cell switch with short delay. Any example embodiment may be combined with one or more other example embodiments. These and other aspects of the present disclosure will be apparent from the example embodiment(s) described below. According to some aspects, there is provided the subject matter of the independent claims. Some further aspects are defined in the dependent claims.

### DESCRIPTION OF THE DRAWINGS

The accompanying drawings, which are included to provide a further understanding of the example embodiments and constitute a part of this specification, illustrate example embodiments and, together with the description, help to explain the example embodiments. In the drawings:

FIG. 1 illustrates an example of a communication network;

FIG. 2 illustrates an example of components of a 5G New Radio (NR) network topology

FIG. 3 illustrates an example of an apparatus configured to practice one or more example embodiments;

FIG. 4 illustrates an example of delays associated with a Layer 3 (L3) handover procedure;

FIGS. 5A and 5B illustrate an example of a message sequence and operations for L1/L2 triggered mobility;

FIG. 6 illustrates an example of a UE capability exchange for LTM;

FIGS. 7A and 7B illustrate an example of delivery of LTM capability information;

FIGS. 8A and 8B illustrate an example of a message sequence and operations when transmitting an LTM uplink indication in a RRC reconfiguration complete message;

FIGS. 9A and 9B illustrate an example of a message sequence and operations when transmitting an LTM uplink indication in a medium access control (MAC) control element (CE);

FIGS. 10A and 10B illustrate an example of a message sequence and operations when transmitting an LTM uplink indication in a MAC CE;

FIGS. 11A and 11B illustrate an example of a message sequence and operations when RRC configuration indicates LTM priority;

FIG. 12 illustrates an example of a method for indicating ability of pre-processing a RRC reconfiguration before cell switch;

FIG. 13 illustrates an example of a method for pre-processing a RRC reconfiguration;

FIG. 14 illustrates an example of a method for indicating a UE capability of pre-processing a RRC reconfiguration before cell switch;

FIG. 15 illustrates an example of a method for configuring LTM delay(s) based on an indication related to a pre-processed part of LTM related RRC reconfiguration message;

FIG. 16 illustrates a method for instructing a UE to pre-process at least part of LTM related part of a RRC message; and

FIG. 17 illustrates a method for configuring LTM delay(s) based on an indication of a UE capability to support LTM pre-processing.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

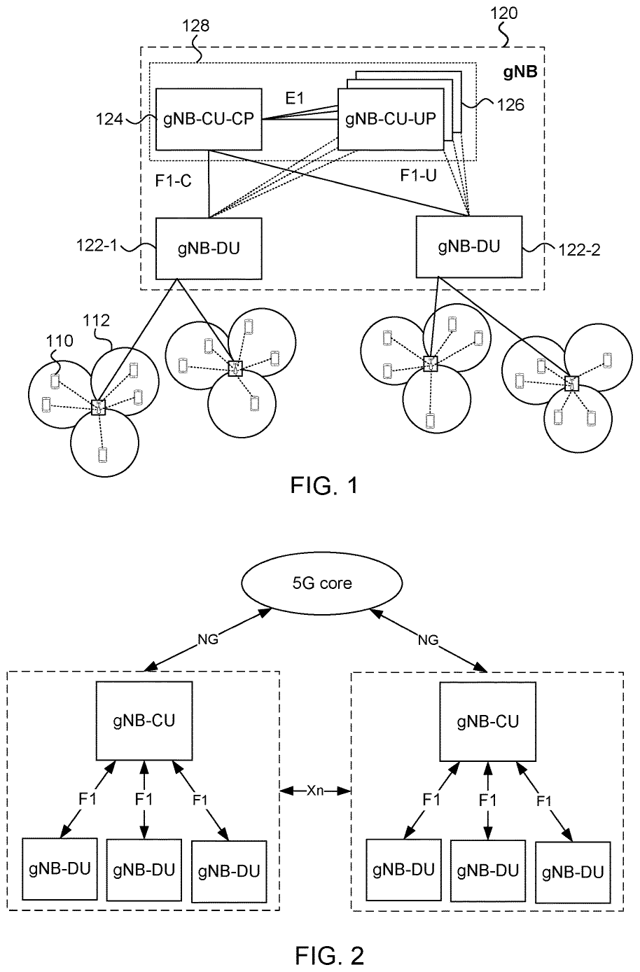

A UE may connect to different cells of a network and use L1 and/or L2 signaling to perform mobility (handover) procedures between the cells, for example intra-DU (distributed unit or distributed node) or inter-DU cell switch within a single central unit (CU) of an access node. In L1/L2 triggered mobility, a medium access control (MAC) control element or downlink control information (DCI) may trigger the cell switch. L1 measurements may be used at execution phase of the cell switch. Such procedure may be referred to as L1/L2 mobility. Example embodiments of the present disclosure may provide mechanisms and procedures for L1/L2-based inter-cell mobility that enable reduction of latency in L1/L2 triggered mobility (LTM), enable configuration and maintenance for multiple candidate cells to allow fast application of configurations for candidate cells, provide a dynamic switch mechanism among candidate serving cells (including special cells, SpCell, and secondary cells, SCell) for applicable scenarios based on L1/L2 signalling, provide L1 enhancements for inter-cell beam management (e.g., including L1 measurement and reporting and/or beam indication), and enable timing advance management, provide central unit (CU)/distributed unit (DU) interface signaling to support LTM. Distribution of processing of an access node to a CU and one or more DUs is described with reference to FIG. 1. The described procedures of L1/L2-based inter-cell mobility may be applicable to the following scenarios:
standalone, carrier aggregation (CA), or 5G new radio (NR) dual connectivity (NR-DC) with serving cell change within one configured grant (CG),
intra-DU case and intra-CU inter-DU case (applicable for standalone and CA),
both intra-frequency and inter-frequency mobility,
both Frequency Range 1 (FR1) and Frequency Range 2 (FR2), or
source and target cells being synchronized or non-synchronized.

Example embodiments of the present disclosure enable to reduce the handover (inter-cell mobility) latency, for example in the scenarios described above. In L1/L2 triggered mobility (LTM), a UE may be configured to report L1 beam measurements to a serving DU (source DU). Based on the L1 beam measurements the serving DU may decide when to trigger the handover. This enables to simplify many of the network and UE mobility procedures as well as reduce the interruption time or delay caused by the mobility. Furthermore, network data forwarding and scheduling may also benefit from LTM. In LTM, the UE may maintain configuration of multiple cells to enable fast application of each configuration. LTM may involve serving cell change or not, and it can use either the random access channel (RACH) or be RACH-less.

In LTM, the serving DU may trigger execution of a prepared target cell configuration based on lower layer (L1/L2) signaling, which may for example include a medium access control (MAC) control element (CE) or downlink control information (DCI). Upon triggering the cell change, the serving DU may inform the CU, which may terminate sending any RRC reconfiguration messages over the serving cell radio link and initiate data forwarding to the target cell.

LTM may use L1 measurements. These measurements have the benefit of faster reaction time to radio link degradation in the serving link, for example because the network can save the delay introduced by Layer 3 (L3) filtering and a time-to-trigger (TTT) delay for the handover decision. This enables to reduce the number of radio link failures compared to non-L1/L2 based handover.

FIG. 1 illustrates an example of a split access node architecture. An access node, represented throughout the description by gNB 120, may be split, functionally and/or physically, to a central unit (CU) 128 and one or more distributed units (DU), in this example two DUs 122-1 and 122-2. CU 128 may be also referred to as gNB-CU and DU(s) be also referred to as gNB-DU(s). CU 128 may comprise control plane (CP) and user plane (UP) entities, represented by gNB-CU-CP 124 and gNB-CU-UP 126, respectively. The gNB-CU-CP 124 may be configured to control communication of signaling data that enables transfer of user/application data at the user plane. User plane communications may be provided by one or more gNB-CU-UPs 126 associated with gNB-CU-CP 124. CU 128 and DU(s) 122-1, 122-2 may be configured to provide radio access network (RAN) services to device(s), represented by user equipment (UE) 110, at one or more cells 112.

Control and user plane entities of CU 128 may communicate via a communication interface, such as for example an E1 interface. CU 128 may communicate with a DU over a communication interface, such as for example an F1 interface. The F1 interface may comprise control and user plane interfaces (F1-C, F1-U) between a DU and the control and user plane entities of CU 128, respectively. Even though two DUs are illustrated in FIG. 1, a CU may be in general associated with one or a plurality of DUs.

The CU/DU-split architecture enables disaggregation of the RAN, thus enabling operators to utilize different vendors for different network nodes, but also to enable network vendors to split their network implementations for scalability purposes. For example, control and user planes may be separated to their own entities, thereby enabling control and user plane functions to be dimensioned separately. The split may be however (almost) invisible to a user equipment (UE) and therefore, at the UE side, the protocol layers may be (mostly) unaware of the split, except for minor parts which the UE may implicitly determine from the associated radio resource control RRC configuration. In case of intra- or inter-DU handover, the network may be configured to explicitly control which part of the protocol stack is reconfigured. This may be included in the RRC processing and therefore the RRC delay may be variable, or static but with different delays for different scenarios.

A UE 110 may access application services via the RAN, which may comprise one or more gNBs 120. UE 110 may communicate with gNB 120 over a radio interface, configured for example based on the 5G NR (New Radio) standard defined by the 3^{rd} Generation Partnership Project (3GPP). Communication network 100 may therefore comprise a wireless communication network.

Communication network 100 may be operated based on a protocol stack comprising a plurality of protocol layers. The protocol stack may be arranged based on the open systems interconnection (OSI) model or a layer model of a particular standard (e.g., a 3GPP standard). In one example, the protocol stack may comprise a service data adaptation protocol (SDAP) layer, which may receive data from an application layer for transmission. The SDAP layer may be configured to exchange data with a packet data convergence (PDCP) layer. The PDCP layer may be responsible of generation of data bursts comprising one or more data packets, for example based on data obtained from the SDAP layer.

The PDCP layer may provide data to one or more instances of a radio link control (RLC) layer. For example, PDCP data may be transmitted on one or more RLC transmission legs. Each RLC instance may be associated with corresponding MAC instances of a MAC layer (Layer 2). The MAC layer may provide a mapping between logical channels of upper layer(s) and transport channels of the physical layer, handle multiplexing and demultiplexing of MAC service data units (SDU). Furthermore, the MAC layer may provide error correction functionality based on packet retransmissions, for example according to the hybrid automatic repeat request (HARQ) process. Physically separate transmission legs may be provided by the physical (PHY) layer, also known as Layer 1 (L1). The RLC, MAC, and L1 functionality may reside on DU(s) 122-1, 122-2. Corresponding protocol stacks may be applied both at gNB 120 and UE 110.

In a split access node architecture part of the protocol layers may be implemented at CU 128. In the example of FIG. 1, CU 128 (e.g., CU-UP 126) may be configured to handle upper layers of the protocol stack, for example SDAP and PDCP layers. Furthermore, CU 128 (e.g., CU-CP 124) may be configured to handle radio resource control (RRC) operations. DU(s) 122-1, 122-2 may be configured to handle lower layers of the protocol stack, for example RLC, MAC, and L1. A user plane (U-plane) control function may interact with the MAC layer to encapsulate RRC data received from CU-CP 124 in MAC packets and/or decapsulate RRC data from MAC packets and provide the RRC data to CU-CP 124. Radio unit(s) of the DU(s) 122-1, 122-2 may transmit/receive data to/from UE(s) over a radio interface.

As noted above, one CU may include, or be configured to control, several DUs. Furthermore, one DU may serve multiple cells, for example tens of cells. Providing the RRC layer in CU 128 may enable good control of mobility of UE 110 and also enable it to operate as a central resource manager for UE 110. DUs 122-1, 122-2 may include a resource manager that controls lower layer radio parameter usage, e.g., periodical physical uplink control channel (PUCCH) resources, and also some central computing unit (CPU) computing resources.

Communication network 100 may comprise other network function(s), network device(s), or protocol(s), in addition, or alternative to, those mentioned above. Even though some embodiments have been described in the context of 5G network, it is appreciated that embodiments of the present disclosure are not limited to this example network. Example embodiments may be therefore applied in any present or future communication networks. An apparatus may comprise, or be configured to implement, e.g. by means of software, one or more of the protocol layers described herein. FIG. 2 illustrates an example of components of a 5G New Radio (NR) network topology. As user equipment (UE) moves through a wireless communication system, it may move through regions of radio coverage (cells) supported by one or more radio access network node. Maintaining an ability for UE to communicate effectively with the wireless communication system as it moves through regions of radio coverage is typically referred to as mobility. The operational characteristics of cells supported by network access nodes within a wireless communication network may differ. The wireless communication system may comprise various Transmission and Reception Points (TRPs).

It is envisaged that multiple transmission and reception points mTRPs may be used in a 5G NR network to improve reliability, coverage and capacity performance through flexible deployment scenarios. Multi-TRP operates to alleviate intercell interference via dynamic coordination between multi TRPs to provide joint scheduling and transmission/reception. Wireless devices, such as UEs at a cell edge may be served by multi TRPs to improve signal transmission and/or reception, resulting in increased throughput. The following description may provide further details of alternatives, modifications and variances in a 5G NR network: a gNB may comprise, e.g., a node providing NR user plane and control plane protocol terminations towards UE 110, and connected via the NG interface to the 5GC, e.g., according to 3GPP TS 38.300 V16.6.0 (3021-06) section 3.2 incorporated herein by reference.

A gNB Central Unit (gNB-CU) comprises e.g. a logical node hosting e.g. RRC (radio resource control), SDAP (service data adaptation protocol) and PDCP (packet data convergence protocol) protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC (radio link control), MAC (medium access control) and PHY (physical) layers of the gNB or en-gNB, and its operation is partly controlled by the gNB-CU. One gNB-DU supports one or multiple cells. One cell may be supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.501 V16.6.0 (3021-07) section 3.1 incorporated by reference.

Different functional splits between the central and distributed unit are possible, e.g. called options:

Option A (1A-like split): The function split in this option is similar to the 1A architecture in DC. RRC is in the central unit. PDCP, RLC, MAC, physical layer and RF are in the distributed unit.

Option B (3C-like split): The function split in this option is similar to the 3C architecture in DC. RRC and PDCP are in the central unit. RLC, MAC, physical layer and RF are in the distributed unit.

Option C (intra RLC split): Low RLC (partial function of RLC), MAC, physical layer and RF are in the distributed unit. PDCP and high RLC (the other partial function of RLC) are in the central unit.

Option D (RLC-MAC split): MAC, physical layer and RF are in the distributed unit. PDCP and RLC are in the central unit.

Or else, e.g. according to 3GPP TR 38.801 V14.0.0 (2017-03) section 11 incorporated herein by reference.

A gNB may support different protocol layers, e.g. Layer 1 (L1)—physical layer. The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.: The physical layer offers to the MAC sublayer transport channels; The MAC sublayer offers to the RLC sublayer logical channels; The RLC sublayer offers to the PDCP sublayer RLC channels; The PDCP sublayer offers to the SDAP sublayer radio bearers; The SDAP sublayer offers to 5GC QoS flows; Comp. may refer to header compression and Segm. to segmentation; Control channels include (BCCH, PCCH).

Layer 3 (L3) includes e.g. Radio Resource Control (RRC), e.g. according to 3GPP TS 38.300 V16.6.0 (3021-06) section 6 incorporated herein by reference.

A RAN (Radio Access Network) node or network node or central node or distributed node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3. They may also be implemented using specific means configured to perform respective specific tasks, e.g. layer 3 means to perform layer 3 operations, layer 2 means to perform layer 2 operations, etc. A central node may e.g. implement CU-CP and/or CP-UP functionality.

The gNB CU and gNB DU parts may e.g. be co-located or physically separated. The gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

A gNB-DU supports one or multiple cells, and could thus serve as e.g. a serving cell for a user equipment (UE).

In other words: A 5G base station or “network node” named gNB can be divided into two physical entities named CU (Centralized Unit) and DU (Distributed Unit).

CU provides support for the higher layers of the protocol stack such as SDAP, PDCP and RRC (and in particular layer 3 protocol like RRC) while DU provides support for the lower layers of the protocol stack such as RLC, MAC and Physical layer (in particular layer 1 like Physical layer and layer 2 protocol like RLC and MAC). Also, note that SDAP layer will not be present if the CU is connected to a 4G Core network as we should have 5G core network to support SDAP. There may be a single CU for each gNB, but one CU may control multiple DUs, for example more than 100 DUs can be connected to one CU.

Each DU is able to support one or more cells, so one gNB can control hundreds of cells unlike a 4G base station. Also, note that the interface between CU and DU is named F1 and as per 3GPP, it should be an open interface, so you connect one CU from vendor X to another DU from vendor Y.

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (3021-06) sections 42.1 and 4.4, incorporated by reference).

A UE is e.g. either in RRC_CONNECTED state or in RRC_INACTIVE state when an RRC connection has been established.

In RRC_CONNECTED state a UE may: store the AS context; transfer unicast data to/from the UE; monitor control channels associated with the shared data channel to determine if data is scheduled for the data channel; provide channel quality and feedback information; and/or perform neighbouring cell measurements and measurement reporting;

The RRC protocol includes e.g. the following main functions: RRC connection control; measurement configuration and reporting; establishment/modification/release of measurement configuration (e.g. intra-frequency, inter-frequency and inter-RAT measurements); setup and release of measurement gaps; and/or measurement reporting.

As networks have developed, and particularly in 5G New Radio (NR) systems, rather than being controlled by the core network, inter-cell mobility is implemented such that it is configured to be layer 1 (L1 or PHY layer) or layer 2 (L2 or MAC layer) centric (L1/L2-centric). Within the 5G NR framework, various methodologies to implement L1/L2-centric inter-cell mobility are possible, and may be selected based upon varying operational scenarios as described further below.

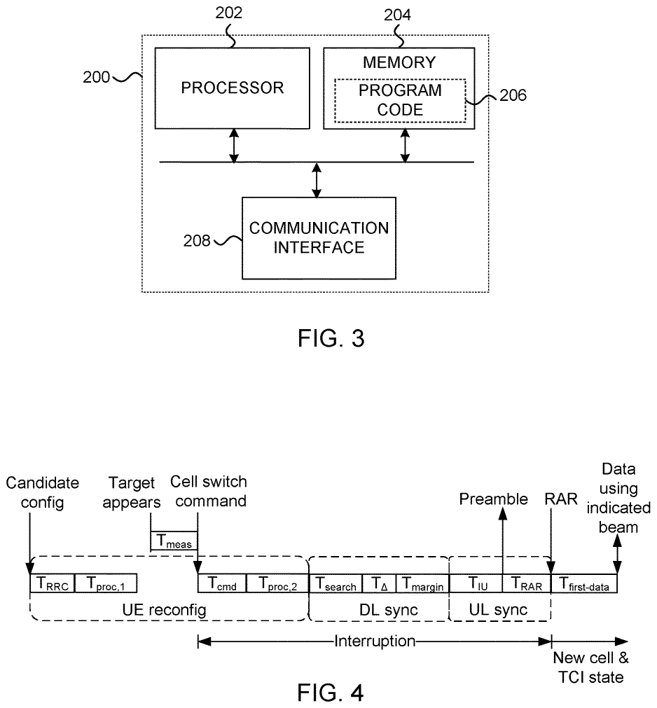

FIG. 3 illustrates an example of an apparatus configured to practice one or more example embodiments. Apparatus 300 may comprise a device such as for example a user equipment, an access node, an access point, a base station, a radio network node, or a split portion thereof, or in general a device configured to implement functionality described herein. Apparatus 300 may comprise at least one processor 302. The at least one processor 302 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

Apparatus 300 may further comprise at least one memory 304. The memory 304 may be configured to store, for example, computer program code or the like, for example operating system software and application software. The memory 304 may comprise one or more volatile memory devices, one or more non-volatile memory devices, and/or a combination thereof. For example, the memory may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.). Memory 304 is provided as an example of a (non-transitory) computer readable medium. The term “non-transitory,” as used herein, is a limitation of the medium itself (i.e., tangible, not a signal) as opposed to a limitation on data storage persistency (e.g., RAM vs. ROM).

Apparatus 300 may further comprise a communication interface 308 configured to enable apparatus 300 to transmit and/or receive information. The communication interface 308 may comprise an internal or external communication interface, such as for example an E1, F1, F1-C, and/or F2-C interface, or a radio interface. Apparatus 300 may further comprise other components and/or functions such as for example a user interface (not shown) comprising at least one input device and/or at least one output device. The input device may take various forms such a keyboard, a touch screen, or one or more embedded control buttons. The output device may for example comprise a display, a speaker, or the like.

When apparatus 300 is configured to implement some functionality, some component and/or components of apparatus 300, such as for example the at least one processor 302 and/or the at least one memory 304, may be configured to implement this functionality. Furthermore, when the at least one processor 302 is configured to implement some functionality, this functionality may be implemented using program code 306 comprised, for example, in the at least one memory 304.

The functionality described herein may be performed, at least in part, by one or more computer program product components such as software components. According to an example embodiment, apparatus 300 comprises a processor or processor circuitry, such as for example a microcontroller, configured by the program code 306, when executed, to execute the embodiments of the operations and functionality described herein. Program code 306 is provided as an example of instructions which, when executed by the at least one processor 302, cause performance of apparatus 300.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), graphics processing units (GPUs), or the like.

Apparatus 300 may be configured to perform, or cause performance of, method(s) described herein or comprise means for performing method(s) described herein. In one example, the means comprises the at least one processor 302, the at least one memory 304 including program code 306 configured to, when executed by the at least one processor 302, cause apparatus 300 to perform the method(s). In general, computer program instructions may be executed on means providing generic processing functions. Such means may be embedded for example in a personal computer, a smart phone, a network device, or the like. The method(s) may be thus computer-implemented, for example based algorithm(s) executable by the generic processing functions, an example of which is the at least one processor 302. The means may comprise transmission or reception means, for example one or more radio transmitters or receivers, which may be coupled or be configured to be coupled to one or more antennas, or transmitter(s) or receiver(s) of a wired communication interface. Although apparatus 300 is illustrated as a single device, it is appreciated that, wherever applicable, functions of apparatus 300 may be distributed to a plurality of devices.

FIG. 4 illustrates an example of delays associated with a Layer 3 (L3) handover procedure. UE 110 may receive a candidate configuration indicative of one or more handover target cells. This may cause a processing delay T_{RRC} (e.g., up to 10 ms) at UE 110 for processing a RRC reconfiguration (RRCReconfiguration) message carrying the candidate configurations. Delay T_{proc,1} may refer to UE processing time before a cell switch command. This may include L2/L3 reconfiguration, retuning of RF (radio frequency) parts, baseband retuning, security update, or the like. This delay may be up to 20 ms for same Frequency Range and up to 40 ms for different Frequency Ranges. When a target cell appears, measurement delay Tₘₑₐₛ may occur between appearing of the target cell and the cell switch command. After receiving the cell switch command, delay T_{cmd} may occur due to processing of this L1/L2 command (e.g., due to hybrid automatic repeat request (HARQ) procedure and parsing). This delay may be for example up to 5 ms. Another processing delay T_{proc,2} may occur after T_{cmd} before completion of UE reconfiguration. Duration of T_{proc,2} may be similar to T_{proc1} and it may occur due to similar reasons.

Delay T_{search} may include the time required for searching for the target cell. This delay may be non-existent if the target cell is known, but it may be for example up to 60 ms if the target cell is unknown. Delay TA may occur due to time spent for fine tracking and acquiring full timing information. This may depend on synchronization signal/block measurement timing configuration (SMTC) and be for example 20 ms. Delay T_{margin} may occur due to synchronization signal block (SSB) or channel state information reference signal (CSI-RS) post-processing. Delays T_{search}, T_{Δ}, and T_{margin} may be associated with downlink (DL) synchronization.

Delay T_{IU} may occur due to interruption uncertainty in acquiring the first physical random access channel (PRACH) occasion in the target cell. Delay T_{RAR} may occur between transmission of the random access (RA) preamble and reception of a random access response (RAR) by UE 110. Delays T_{IU} and T_{RAR} may be associated with uplink (DL) synchronization.

Delay T_{first-data} may occur between reception of the random access response by UE 110 and initiating data communication with an indicated beam. An interruption time may occur between reception of the cell switch command and initiation of the data communication with the indicated beam. After this, data may be communicated with the new cell and with a new transmission configuration information (TCI) state.

RRC configuration received by UE 110 may therefore contain various configurations and it may take a long time to process it. It may require significant effort for UE 110 to validate and process the configuration. Therefore, in one approach of handover, UE 110 may validate the RRC configuration as it receives it, and process the configuration as UE 110 knows exactly what to process. For example, in case of L3 handover, the time when UE 110 performs this may be denoted by T_{proc,2}.

Furthermore, there are many ways UEs can process the RRC configuration. Some UEs may be able to process the full RRC configuration upon receiving it, but others may just validate the configuration and process it later. Therefore, some handover requirements may be designed based on the worst case scenario. This may not be optimal for LTM that aims to reduce the processing delay to minimum.

UE LTM RRC processing may include a decoding and validation/compliance check. UE 110 may determine to perform this either once it receives the command or once the cell switch command is received. UE 110 may generally not provide information the network on whether the command processing happens before or after the switch command. Therefore, UE requirements may be again designed based on the worst case scenario.

Example embodiments of the present disclosure provide methods to reduce the service interruption time related to RRC processing in L1/L2 triggered handover. This may be achieved by addressing how the RRC data is processed at UE 110. UE 110 may indicate its RRC processing capability to the network, for example by explicit signalling or by a UE capability associated with this processing.

When compared to the UE delays associated with L3 handover, at least the following areas of improvement may be identified:

A first set of methods, referred to herein as Options 1 to 3, comprise example embodiments, where a LTM UL indication (LTM_UL_indication) is signalled from UE 110 to the network. This indication enables the network to be informed about the processing status of RRC configuration at UE 110. Based on this information, the network may determine that UE 110 does not need to process the RRC configuration upon receiving the cell switch command and that UE service switch in LTM can have a shorter delay. Based on the LTM UL indication the network may determine that UE 110 has performed a syntax notation check and/or a compliance check for the RRC configuration, for example an ASN.1 (Abstract Syntax Notation One) validity and/or compliance check.

A second type of method (Option 4) may comprise a downlink indication, for example in a RRC reconfiguration command, from the network to ULE 110. This indication enables UE 110 to be requested to validate the received RRC-LTM configuration, process the RRC-LTM configuration, and/or prepare UE 110 ready for cell switch, before the cell switch command is received, for example via a MAC CE or DCI.

Following terminology may be used: LTM may refer to L1/L2-triggered mobility. Cell switch may comprise a procedure of triggering change of cells, for example via the LTM feature. Subsequent LTM may refer to a case where cell switch between L1/L2 mobility candidates is done without RRC reconfiguration in between. A LTM configuration (LTM_config) may comprise one or more RRC configurations that includes LTM specific information elements. RRC ASN.1 validation may comprise validation of generic ASN.1 syntax and/or completeness validation. LTM evaluation (LTM_evaluation) may comprise ULE 110 evaluating the LTM configuration and extracting information, for example one or more of the following: user plane configuration (e.g., change(s) required for MAC, RLC, PDCP, or SDAP), whether RF retuning is required after a cell switch command (LTM_switch_command), whether baseband retuning is required after a cell switch command (LTM_switch_command), or whether UE 110 is able to perform a RACH-less access procedure (e.g., by evaluating timing advance (TA) configuration). In response to evaluation of the LTM configuration, UE 110 may initiate preparations for further processes, such as a RACH-less access process to a target DU. LTM priority (LTM_priority) may comprise an indication of high priority for RRC-LTM configuration validation, processing, and/or preparation at UE 110. LTM uplink (UL) indication (LTM_UL_Indication) may indicate whether UE 110 is able to process the LTM configuration before the cell switch command. The LTM UL indication may indicate what parts of the RRC configuration are left for processing after the cell switch command LTM switch command (LTM_switch_command) may comprise a cell switch command, for example a MAC CE or DCI. LTM measurements (LTM_measurements) may comprise L1 or L3 handover measurements with or without an uplink indication.

One or more of the following performance enhancements may be targeted:
Security update may not need to be supported with L1/L2 based mobility.
ASN.1 decoding and validity/compliance check of candidate cell configuration may be performed upon reception of the candidate cells configuration.
For UE processing, the following (not exhaustive) operations may be performed after receiving the cell switch command: MAC/RLC reset (when configured), RF retuning (e.g. needed for inter-frequency), baseband retuning.
Performing DL synchronization to candidate/target cell before receiving the cell switch command, for example at least for the case that the target cell is already an active serving cell.
Support performing tracking reference signal (TRS) tracking and CSI measurement of candidate/target cell before/by cell switch command.

L1/L2-based mobility may be configured to support the following carrier aggregation (CA) scenarios: PCell (primary cell) change without SCell change or PCell change with SCell change. Furthermore, Support for NR-DC scenario in L1/L2-based mobility may be provided, at least for the case of PSCell (primary and secondary cells) change without master node (MN) involvement case, i.e., intra-SN (secondary node).

The following scenarios may be considered for L1 measurements and beam indication:
Event reporting or filtering may be supported.
Inter-frequency L1/L2 mobility: inter-frequency scenarios in general may be supported for L1/L2 mobility (including mobility to inter-frequency cell that is not a current serving cell), including the support of inter-frequency L1 measurements.
A unified TCI framework may be used for beam indication for L1/L2 mobility.

The following scenarios may be considered for dynamic cell switching:
L1/L2 mobility trigger information may be conveyed in a MAC CE. The MAC CE or DCI may be used for the actual triggering of the L1/L2 mobility.
MAC CE for L1/L2 mobility trigger may contain at least a candidate configuration index.
Performing SCell activation/deactivation (e.g., amongst SCells associated with the candidate configuration) simultaneously with L1/L2 mobility trigger MAC CE.
RACH-based (e.g., contention-free random access (CFRA), contention-based (CBRA)) and RACH-less procedures for L1/L2 mobility switch may be supported. RACH-less access may be used for example if the UE does not need to acquire timing advance (TA) during the cell switch.
RACH resource for CFRA for L1/L2 dynamic switch may be provided in RRC configuration or in a MAC CE.
The MAC CE may indicate TCI state(s) (or other beam info) to be activated for the target cell(s).
At L1/L2 cell switch: Whether the UE performs partial or full MAC reset, re-establishes RLC, performs data recovery with PDCP may be controlled by the network. This can be configured by RRC. Alternatively, or additionally, MAC CE indication(s) may be used.

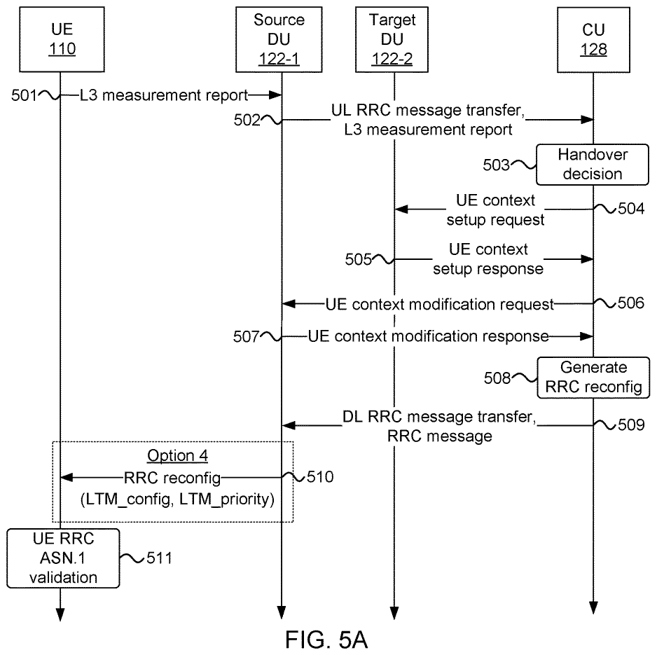

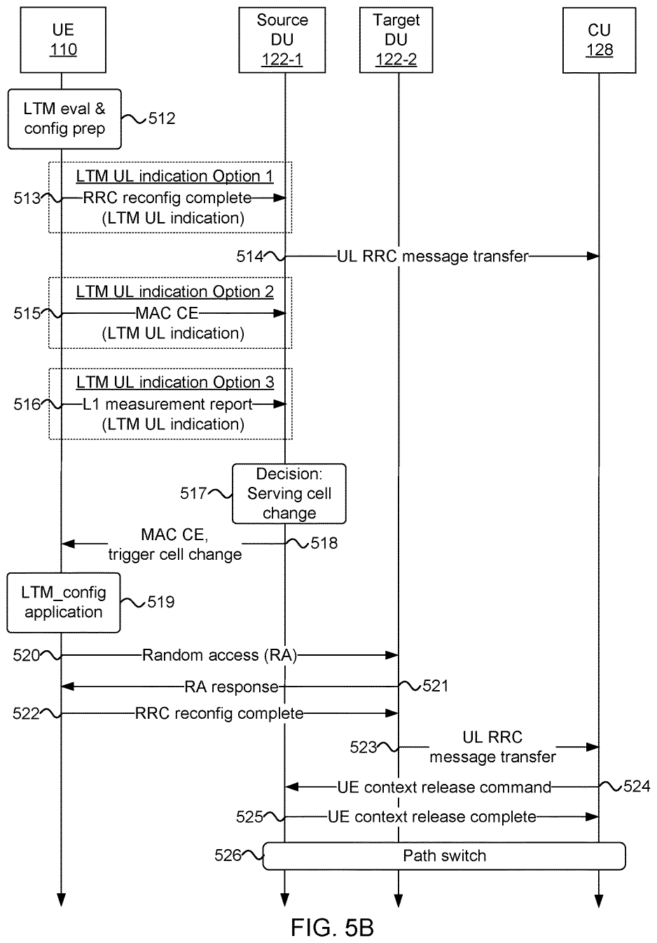

FIGS. 5A and 5B illustrate an example of a message sequence and operations for L1/L2 triggered mobility. The L1/L2 related procedure may involve UE 110, DU 122-1 (in this example acting as a source DU), DU 122-2 (target DU), and CU 128. As illustrated in FIG. 1, source DU 122-1 and target DU 122-2 may be associated with, e.g., controlled by, same CU 128. It is however possible that the disclosed L1/L2 mobility procedures may be performed for DUs that are associated with different CUs. Operations of source DU 122-1, target DU 122-2, and CU 128 may be performed by an access node, for example gNB 120.

At operation 501, UE 110 may transmit a L3 measurement report to source DU 122-1.

At operation 502, source DU 122-1 may transmit the L3 measurement report to CU 128, for example using UL RRC message transfer.

At operation 503, CU 128 may make a handover decision. The decision may be based on the L3 measurement report.

At operation 504, CU 128 may transmit a UE context setup request to target DU 122-2. The UE context setup request may be a CU-initiated context setup request.

At operation 505, target DU 122-2 may transmit a UE context setup response to CU 128.

At operation 506, CU 128 may transmit a UE context modification request to source DU 122-1.

At operation 507, source DU 122-1 may transmit a UE context modification response to CU 128.

At operation 508, CU 128 may generate a RRC (re)configuration for LTM (RRC-LTM). The RRC-LTM (re)configuration may comprise a measurement configuration of L1 cell change and/or a configuration of prepared target cells for the handover.

At operation 509, CU 128 may transmit a RRC message to source DU 122-1, for example using downlink (DL) RRC message transfer. The RRC message may comprise the RRC-LTM (re)configuration generated at operation 508.

According to one approach, operation 509 may be followed by transmission of a RRC reconfiguration message to UE 110 by source DU 122-1, transmission of a RRC reconfiguration complete message to source DU 122-1 by UE 110, and periodic transmissions of L1 measurement reports by UE 110 to source DU 122-1, which may trigger the handover. However, operations 510 to 519 as described herein enable to reduce the delay when performing the handover. Transmission of a L1 measurement report may initiate a handover execution phase, which may be subsequent to a handover preparation phase, which may comprise for example operations until transmission of the L1 measurement report.

At operation 510, source DU 122-1 may transmit a RRC reconfiguration message. The RRC reconfiguration message may comprise the RRC-LTM (re)configuration (LTM_config) received from CU 128. The RRC reconfiguration message may comprise an indication of a priority (LTM_priority) for validation, processing, or preparation of the RRC configuration at UE 110. The indication of priority may be set to a (high) value indicative of a request to prioritize the validation, processing, or preparation of the RRC configuration at UE 110, for example such that the RRC configuration is validated, processed, or prepared before reception of the cell switch command (cf. operation 518) at UE 110. Alternatively, the LTM_config or LTM_priority may be transmitted in some other control message. Operation 510 is provided as an example implementation for Option 4 mentioned above.

At operation 511, UE 110 may perform validation of the received LTM_config. For example, UE 110 may perform validation of a syntax notation check, for example ASN.1 validation, for the RRC configuration (LTM_config). This may include validation of ASN.1 syntax of the LTM_config, but for example not necessarily validation of completeness of the LTM_config.

At operation 512, UE 110 may perform LTM evaluation and LTM configuration preparation. For example, UE 110 may evaluate feasibility of processing the LTM_config (e.g., RRC Delta config). UE 110 may extract the LTM config, but not yet apply any part of it. UE 110 may evaluate the user plane configuration, for example whether change(s) are required for MAC, RLC, PDCP, or SDAP protocol configuration(s), whether RF or baseband retuning is required for complying with the upcoming cell switch command, or whether UE 110 is able to access target DU 122-2 with a RACH-less access procedure. Based on this evaluation, UE 110 may determine what is the delay of this processing.

UE 110 may determine the delay based on static time delay calculation. For instance, the following delay requirements may be specified: RACH-delay is 10 ms, RACH-less delay is 0, RF retuning delay is 5 ms (inter-frequency only), baseband retuning is 5 ms (inter-frequency only), MAC in intra-DU case is 5 ms, MAC in inter-DU case is 10 ms, RLC delay in intra-DU is 5 ms, RLC delay in inter-DU is 5 ms, MAC CE processing 5 ms. When UE 110 receives RRC configuration that includes those case specific pointers, UE 110 may calculate for example that a preparation delay for RACH-less intra-DU with intra-frequency LTM is RACH-less 0 ms+MAC 5 ms+RLC 5 ms MAC CE (cell switch) 5 ms=15 ms in total It is noted that the numbers are for illustrative purposes only.

In general, UE 110 may determine whether it is able to process the RRC configuration (LTM_config) before reception of the cell switch command. UE 110 may estimate a delay for processing the RRC configuration (LTM_config). Operation 511 and/or 512 may be initiated by UE 110, in response to receiving the indication of LTM_priority at operation 510.

At operation 513, UE 110 may transmit a LTM UL indication to source DU 122-1. The LTM UL indication may comprise an indication of whether UE 110 is able to process the RRC configuration (LTM_config) before the reception of the cell switch command and/or an indication of the estimated delay. This indication may comprise an indication that UE 110 has already processed the received RRC configuration (LTM_config), i.e., an indication of completion of the processing. According to Option 1, the LTM UL indication may be transmitted in a RRC reconfiguration complete message.

At operation 514, UL RRC message transfer may be performed between source DU 122-1 and (target) CU 128.

At operation 515, according to Option 2, UE 110 may transmit the LTM UL indication to source DU 122-1 in a MAC CE. The MAC CE may be dedicated for the LTM UL indication. For example, other signalling information may not be carried in this MAC CE.

At operation 516, according to Option 3, UE 110 may transmit the LTM UL indication to source DU 122-1 in a L1 measurement report. Any of Options 1 to 3 may be combined with Option 4 (cf. operation 510). It is also noted that one or more the messages of Options 1 to 3 may be transmitted (without the LTM UL indication), if the LTM UL indication is provided in another one of these messages.

Alternatively, the LTM UL indication may be implicit. For instance, UE 110 may be configured with a capability to perform RRC pre-processing. Once the network (e.g. gNB 120) has set a corresponding configuration flag in RRC configuration, the network may determine that UE 110 is configured to perform LTM evaluation prior to sending L1 measurements. Hence, an explicit LTM UL indication may not need to be provided, for example when the same information is determined by the network based on UE capability signalling.

For example, in some examples, the capability of LTM RRC delay processing may not be explicitly indicated via UL indication, but it may be specified by UE behaviour and requirements, for example in a standard. In this case, the network (e.g., gNB 120) may determine that processing of the RRC configuration occurs at UE 110 after/before a particular operation of FIG. 4A or 4B, for example after any operation before operation 518.

UE 110 may alternatively provide the information of the LTM UL indication as a UE capability. When UE 110 supports this capability, the network (e.g., gNB 120) may determine that UE 110 is configured to process the RRC configuration in specified step. The UE capability may be for example indicative of at least one of the following:
UE 110 is configured to perform ASN.1 validation and LTM evaluation (cf. operations 511 and 512) (together or separately), in response to receiving the RRC configuration at operation 510, for example right after operation 510 (e.g., as a next operation subsequent to reception of the RRC configuration).
UE 110 is configured to perform (only) operation 511, in response to receiving the RRC configuration at operation 510.
UE 110 is configured to process the RRC configuration (LTM_config) between operations 516 and 518.
UE 110 is configured to perform the processing of the RRC configuration (LTM_config) prior to or after starting the L1 measurements.
UE 110 is configured to initiate LTM evaluation, in response to receiving from the network (e.g., source DU 122-1) an indication of target DU 122-2. Hence, the configuration of a target DU may trigger the LTM evaluation at UE 110.
UE 110 may perform the LTM processing (e.g., ASN.1 validation/evaluation) any time before the LTM_switch_command.

In some examples, the LTM evaluation and syntax notation (e.g., ASN.1) validation may be performed at the same time, for example in parallel. UE 110 may decide to perform ASN.1.validation (cf. operation 511) separately from the LTM evaluation (cf. operation 512).

In some examples, UE 110 may apply the RRC configuration directly after receiving it. UE 110 may be configured to do so, for instance, when UE 110 is configured with multi-rx/tx capability, or UE 110 has multiple protocol stacks where the RRC configuration can be applied. In this case, in response to receiving the cell switch command, UE 110 may switch to a preconfigured RX/TX chain or protocol stack.

In some examples, the UE capability may indicate that UE 110 is not capable of performing RRC pre-processing. In this case, UE 110 may use L3 handover requirements, or alternatively relaxed measurements (e.g., longer time interval between measurements or measurement reports) when compared to UEs that are capable of RRC pre-processing. Alternatively, the capability of RRC pre-processing can be indicated via LTM_UL_indication (e.g., with one of the Options 1 to 3). RRC pre-processing capability may refer to a capability to process the RRC configuration (LTM_config) before the cell switch command.

Source DU 122-1 may hence receive the LTM UL indication, for example in a RRC reconfiguration complete message, MAC CE, L1 measurement report, or as a UE capability of UE 110. Upon receiving the LTM UL indication the network (e.g., source DU 122-1) may assume a different delay profile for UE 110 than without the indication.

At operation 517, source DU 122-1 may decide to perform a serving cell change for UE 110. This may be based on one or more conditions, for example conditions for L1 handover measurements reported by UE 110. Based on the LTM UL indication (e.g., the ability of UE 110 to process the RRC reconfiguration before the cell switch command, the estimated delay in that processing, or the indication of completion of that processing), source DU 122-1 may configure at least one delay value of the handover procedure, for example one or more of delay values D or T, as described below.

In L1/L2 triggered mobility, the LTM delay may comprise a LTM preparation delay and a LTM execution delay, for example as follows:

$${D}_{LTM} = {D}_{LTM \_ preperation} + {D}_{LTM \_ execution} .$$

When UE 110 receives a RRC message implying LTM handover, UE 110 may perform LTM preparation procedure for LTM. LTM RRC preparation delay may include LTM ASN.1 validation delay and LTM RRC evaluation delay:

$${T}_{RCC \_ preperation \_ delay} = {T}_{ASN \text{.1} \_ validation} + {T}_{RCC \_ LTM \_ evaluation} ,$$

T_{RRC_preparation_delay} is the delay of RRC pre-processing (this processing may include ASN.1 validation delay and LTM RRC configuration evaluation delay),
T_{ASN.1_validation} is ASN.1 configuration validation delay, and
T_{RRC_LTM_evaluation} is the delay it takes for UE 110 to perform LTM configuration evaluation and to extract user plane (MAC/RLC/PDCP/SDAP) and/or L1 processing indications the RRC LTM command.

LTM execution time T_{LTM_execution} may comprise the UE execution preparation time for LTM. LTM execution time may starts after UE 110 receives the cell switch command (LTM switch command). For example,

$${T}_{LTM \_ execution} = {T}_{RRC \_ LTM \_ execution \_ intra} + {T}_{LTM \_ switch \_ commmd} ,$$

where
T_{RRC_execution} is the UE delay of applying LTM RRC configuration to L1 and L2 as indicated by the RRC command (RRC configuration), and
T_{LTM_switch_command} is the delay of extracting the target cell information from the switch command and applying the LTM RRC configuration.

LTM processing requirements may be intra- and inter-frequency separated, for example as provided in the following table for LTM execution time:

| | | UE processing |
|---|---|---|
| Delay component | Description | delay |
| T_{LTM}_{_{—}}_{execution}_{_{—}}ᵢₙₜᵣₐ | UE may perform T_{LTMexecution}_{_{—}}ᵢₙₜᵣₐ | N ms |
| | processing based on RRC | |
| | evaluation. | |
| T_{LTM}_{_{—}}_{execution}_{_{—}}ᵢₙₜₑᵣ | UE may perform T_{LTMexecution}_{_{—}}ᵢₙₜₑᵣ | N ms + M ms |
| | processing based on RRC | |
| | evaluation for inter-frequency | |
| | case. | |

N is the maximum LTM execution time for intra-frequency handover.
M is the delay from UE inter-frequency configuration processing (applying configuration inter-frequency).
If RRC configuration indicates explicitly L1 and L2 processing components, UE 110 may be configured to follow explicit processing delays.

Therefore, instead of a single delay for RRC, and due to the fast nature of LTM, the delay may be split into multiple components. Also the preparation and validation operations (cf. operations 511 and 512) may be separated, for example as defined below:

LTM RRC processing: If UE supports a L1/L2 triggered mobility capability (e.g., L1L2-triggered-mobility-r18), the UE RRC processing may comprise RRC preparation and execution of LTM associated components included in the RRC configuration message (cf. LTM_config, operation 510).

$${D}_{LTM} = {D}_{LTM \_ preperation} + {D}_{LTM \_ execution} ,$$

D_{LTM} is a total processing delay including LTM RRC message processing, RRC evaluation, and RRC configuration application to L1 and L2 at UE 110.
T_{LTM_Preparation} is a delay component associated with LTM preparation at UE 110. This delay may include LTM RRC message processing, RRC, and evaluation for L1 and L2 configuration.
T_{LTM_Execution} is a delay component for configuring LTM for L1 and L2 based on LTM switch command. This may be determined based on RRC evaluation.

LTM RRC processing with UL processing indication: If UE 110 supports L1/L2 triggered mobility (e.g., L1L2-triggered-mobility-r18), UE 110 may transmit an UL indication to the network (e.g., source DU 122-1). The UL indication may indicate that UE 110 has performed LTM preparation (T_{LTM_preparation}) and that (only) the execution delay T_{LTM_execution} is left. In this case the network (e.g., gNB 120, for example source DU 122-1) may configure delay value D_{LTM} as follows:

$${D}_{LTM} = {T}_{LTM \_ Execution} .$$

Alternatively, the same effect may be achieved by configuring T_{LTM_preparation}=0. If UL indication includes the LTM execution time (T_{LTM_execution}), the network (e.g., source DU 122-1) may use that delay for LTM execution. For example, when UE 110 has processed the RRC configurations upon receiving them, and there is nothing to prepare after that (e.g., in the intra-DU case), the network may determine the execution time to correspond to T_{cmd} in L3 handover. Also, if UE 110 processes an RRC delta configuration and there is nothing to be changed, then the same delay may be applied. If no UL indication is received from UE 110 (or the UL indication indicates that UE 110 is not able to process the RRC reconfiguration before the cell switch command), the following delay may be applied after the cell switch command (LTM switch command).

$${D}_{LTM} = {T}_{LTM \_ preperation +} {T}_{LTM \_ Execution}$$

LTM processing order: If UE 110 supports L1/L2 triggered mobility (e.g., L1L2-triggered-mobility-r18) UE 110 may perform LTM preparation (T_{Preparation}) before the cell switch command (LTM switch command) and LTM execution (T_{LTM_Execution}) after the cell switch command.

At operation 518, source DU 122-1 may transmit the cell switch command (LTM switch command), for example as a MAC CE configured to trigger the cell change.

At operation 519, UE 110 may apply the RRC reconfiguration (LTM_config). Application of the RRC configuration may be in response to receiving the cell switch command from source DU 122-1. UE 110 may for example perform actions that are left from LTM evaluation of operation 512. UE 110 may for example configure its hardware based on the processing of the RRC (re)configuration in operation 512. UE 110 may apply the delay estimated in operation 512 and indicated to source DU 122-1 for example in one of operations 513, 515, or 516. UE 110 may for example apply the RRC configuration (LTM_config) within the estimated delay. Operation 519 may include fully or partially operations 511 or 512.

At operation 520, random access may be initiated between UE 110 and target DU 122-2. For example, UE 110 may transmit a random access preamble to target DU 122-2.

At operation 521, target DU 122-2 may transmit a random access (RA) response to UE 110, in response to receiving the random access preamble at operation 520.

At operation 522, UE 110 may transmit a RRC reconfiguration complete message to target DU 122-2. Transmission of the RRC reconfiguration complete message may terminate the handover execution phase.

At operation 523, UE UL RRC message transfer may be performed between target DU 122-2 and CU 128, for example to inform CU 128 about the completion of the RRC reconfiguration at UE 110. The UL RRC message transfer may initiate a handover completion phase.

At operation 524, CU 128 may transmit a UE context release command to source DU 122-1. In response to receiving this message, source DU 122-1 may release the UE context of UE 110.

At operation 525, source DU 122-1 may transmit a UE context release complete message to CU 128, for example to inform CU 128 about the release of the UE context of UE 110 at source DU 122-1.

At operation 526, a path switch may be performed from source DU 122-1 to target DU 122-2. For example, data packets to be delivered to UE 110 may be switched to be delivered to target DU 122-2 instead of source DU 122-1.

Four example options (Options 1 to 4) are provided for informing the network about the processing capability/status of the RRC-LTM reconfiguration. Additionally, it is described UE 110 and the network are informed about the LTM capability. The following description provides further examples for the following:
UE capability signalling for LTM processing.
Option1: UE transmits UL indication in RRC reconfiguration complete message
Option2: UE transmits LTM_UL_indication via MAC CE (new MAC CE)
Option3: UE transmits LTM_UL_indication within L1 measurement report.

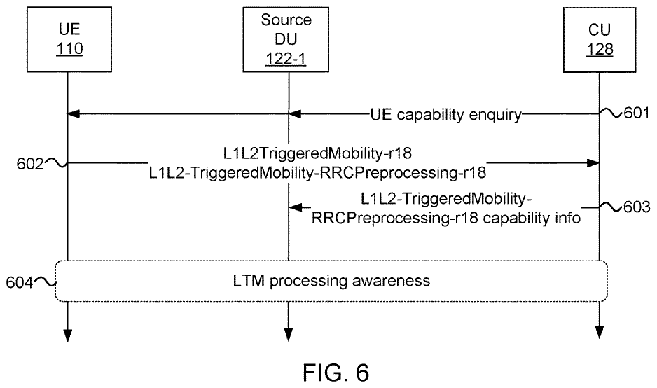

FIG. 6 illustrates an example of a UE capability exchange for LTM. RRC processing capability of UE 110 may be indicated to the network, for example to enable the network in order to follow the procedures described herein. This may be done by utilising UE capability signalling. This capability signalling may be independent of the LTM feature, or it ma be associated with the LTM feature. For instance, if UE 110 supports LTM capability (e.g., flag could be named L1L2TriggeredMobility-rel-18), the behaviour for this capability may be specified in a standard (e.g., in TS 38.133). The indication may be an optional parameter, which may be sent in a RRC setup response message, or configured by the network in the RRC setup message, if UE 110 supports the LTM capability.

UE 110 may report its UE radio access capabilities, which may be static, for example at least when the network requests so. The gNB may request UE 110 to report particular capabilities based on frequency band information. The UE capability may be represented by a capability ID, which may be exchanged in non-access stratum (NAS) signalling over the radio interface and in network signalling instead of the UE capability structure.

The capability may be transmitted using, e.g., a flag (for instance, L1L2-TriggeredMobility-r18) or similar or inherently by indicating support of a standard, or version/release thereof (e.g. Rel. 18). The capability may be transmitted via UECapabilityInformation and/or UECapabilitylnformation-InformationElements (IE) (RRC).

At operation 601, CU 128 may send a UE capability enquiry, which may be transparently transmitted to UE 110 by source DU 122-1

At operation 602, UE 110 may respond to the query (e.g., together with other capabilities) by indicating that it supports LTM (e.g., by capability L1L2TriggeredMobility-r18) and/or LTM RRC pre-processing (e.g., by capability L1L2-TriggeredMobility-RRCPreprocessing-r18)

At operation 603, CU 128 may transmit UE LTM capability information to source DU 122-1. Source DU 122-1 may consider the capability information in its post cell switch processing and scheduling decisions.

At 604, CU 128, source DU 122-1, and UE 110 are aware of the LTM processing.

Example definitions for UE capability signalling are provided in the following table, where M may indicate a mandatory feature, BC may indicate band combination, FDD/TDD may indicate whether the feature is FDD/TDD differentiated, FR1/FR2 may indicate whether the feature is FR1/FR2 differentiated. N/A may indicate no expected impact. Note that the feature may still be used, for instance only for FR2 if, for instance, L1L2-TriggeredMobility-r18, is supported only for FR2. This may not be a technical limitation but limitation of UE implementation.

| | | | FDD − TDD | FR1 − FR2 |
|---|---|---|---|---|
| Definitions for parameters | Per | M | DIFF | DIFF |
| L1L2-TriggeredMobility-r18 | BC | No | N/A | N/A |
| Indicates whether the UE supports L1L2 triggered | | | | |
| mobility. | | | | |
| For example: | | | | |
| Supports MAC CE based cell switch indication. | | | | |
| Supports variable RRC processing delay for LTM | | | | |
| evaluation, LTM config application | | | | |
| L1L2-TriggeredMobility-RRCPreprocessing-r18 | BC | No | N/A | N/A |
| Indicates whether the UE supports RRC pre- | | | | |
| processing, which may comprise one or more of the | | | | |
| following functional components: | | | | |
| ASN.1 Validation/Compliance. ASN.1 validity | | | | |
| and compliance checks are performed and reported | | | | |
| back to the network independently. | | | | |
| LTM RRC evaluation. LTM checks are performed | | | | |
| and reported back to the network independently. | | | | |
| LTM RRC evaluation. LTM checks are performed | | | | |
| and reported back to the network independently. | | | | |
| For example: | | | | |
| UE supports full LTM RRC command pre- | | | | |
| processing. Meaning that LTM command is fully | | | | |
| processed. Result of this processing is indicated | | | | |
| back to the network via RRC setup response. | | | | |
| UE may indicate support of each individual | | | | |
| component via RRC setup-response parameter(s). | | | | |
| LTM_priority. When this flag is set in RRC | | | | |
| configuration LTM RRC processing is | | | | |
| prioritized and UE transmits processing results | | | | |
| in RRC setup complete message. | | | | |
| LTM_UL_Indication - MAC CE based. UE is | | | | |
| configured to transmit LTM_UL_indication in | | | | |
| MACE CE | | | | |
| A UE supporting this feature may also indicate | | | | |
| support of L1L2-TriggeredMobility-r18 | | | | |

Based on the UE capability signalling, CU 128 may be informed about UE 110 supporting LTM pre-processing. However, source DU 122-1 and target DU 122-2 may not be aware of this. It may be desired to inform source DU 122-1 about whether UE 110 supports the RRC pre-processing or not to make decision of cell change. Therefore, CU 128 may transmit the LTM capability information of UE 110 to source DU 122-1, for example as a DU configuration. Source DU 122-1 may apply this configuration assumption after MAC CE processing. This configuration may define the UE RRC processing delay profile for application of the RRC reconfiguration (LTM_config_application).

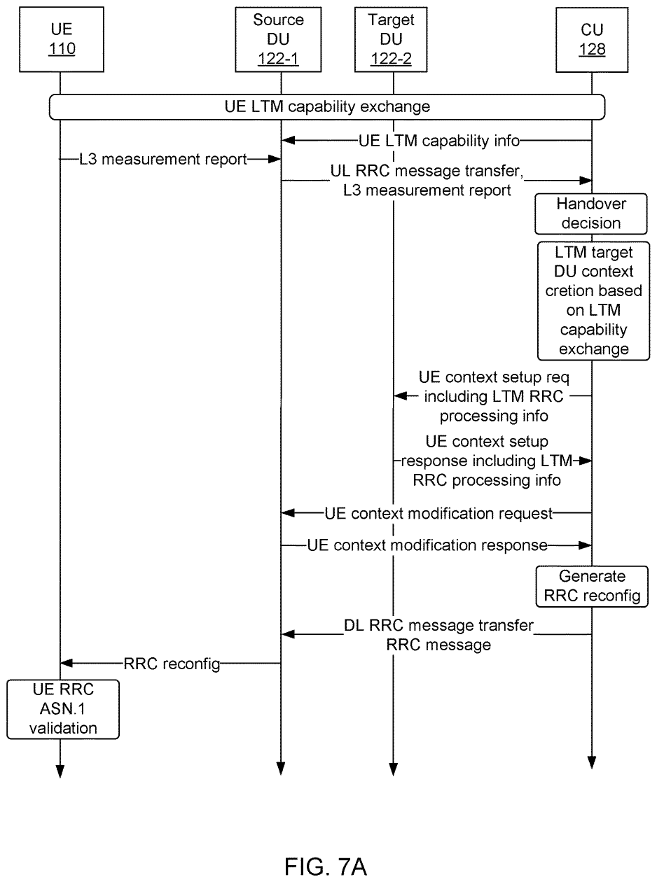

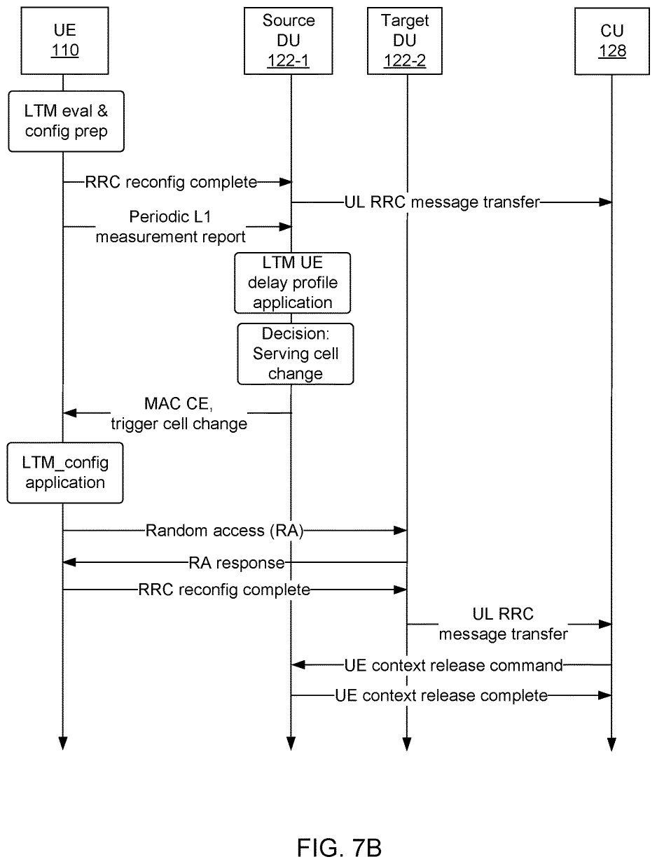

FIG. 7 illustrates an example of delivery of LTM capability information. Initially, UE capability exchange may be performed, for example as described with reference to FIG. 6. This may include transmission of a L3 report between UE 110 and DU.

CU 128 may transmit UE LTM capability information to source DU 122 1.

UE 110 may transmit a L3 measurement report to source DU 122-1.

Source DU 122-1 may forward the L3 measurement report to CU 128, for example by UL RRC message transfer.

CU 128 may make a handover decision.

CU 128 may create UE delay profile for UE 110 based on the UE capability information. CU 128 may consider all the UE LTM processing when creating the delay profile.

CU 128 may transmit the UE configuration to one or more (e.g., all) candidate target cells (target DU(s)). Alternatively, CU 128 may transmit the information to source DU 122-1. Source DU 122-2 may transmit this information to target DU(s) prior to LTM switch decision.

The rest of the operations may be similar to those described with reference to FIG. 5A or 5B. However, source DU 122-1 may apply the LTM UE delay profile before the decision to change the serving cell or transmitting the cell switch command.

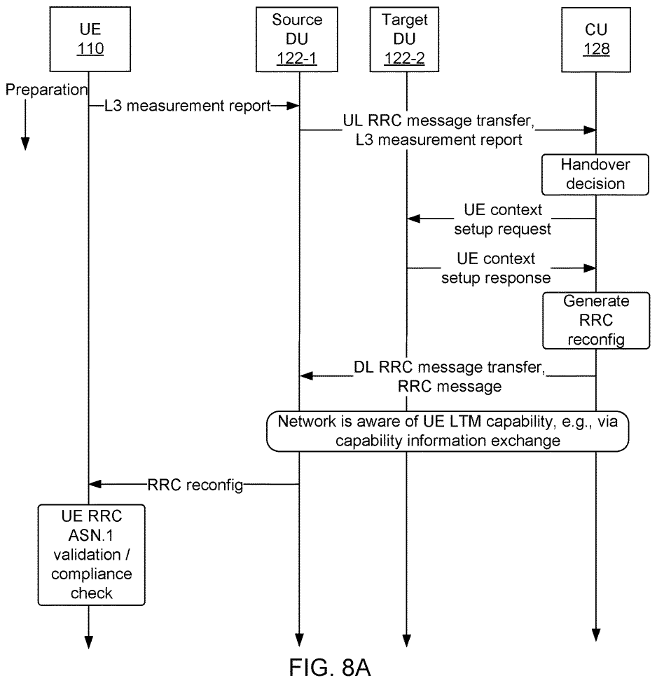

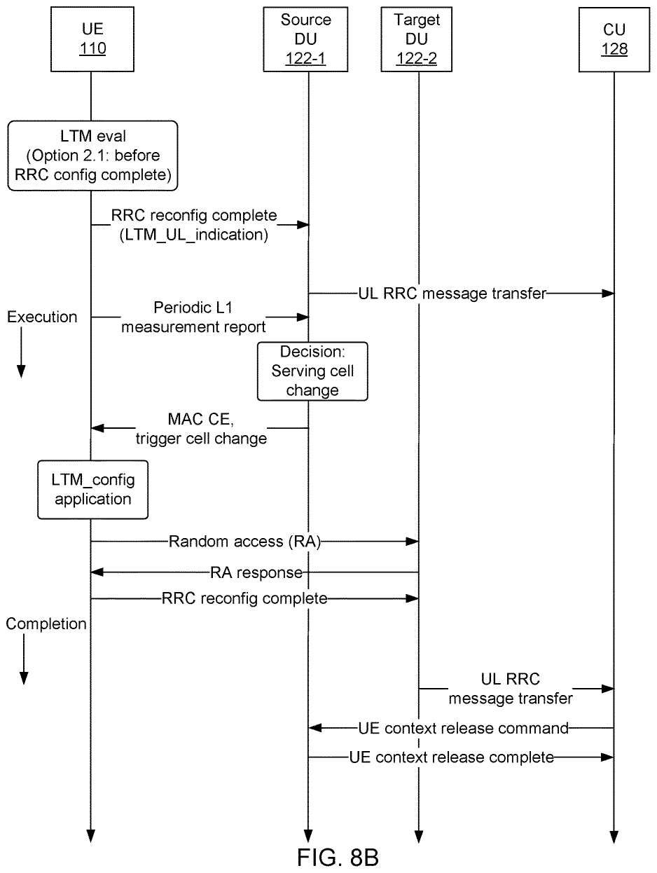

FIGS. 8A and 8B illustrate an example of a message sequence and operations when transmitting an LTM uplink indication in a RRC reconfiguration complete message. Operations of these figures may be similar to corresponding operation of FIG. 5A or 5B, with the following remarks.

After the DL message transfer (cf. operation 509), the network may be aware of the LTM capability of UE 110, for example via a UE capability information exchange. The LTM evaluation (cf. operation 512) may be performed before transmission of the LTM_UL_indication in the RRC reconfiguration complete message. This may be referred to as Option 2.1. In ASN.1 validation, only the ASN.1 syntax may be validated. The LTM UL indication included in the RRC reconfiguration complete message may be configured to indicate to the network that UE 110 has processed the RRC configuration. This may be for example by including an optional parameter in the RRC message, for instance under L1L2TriggeredMobility-r18: rrcPreprocessing=true/yes/1. When set to a logical false value, this parameter may indicate that UE 110 has not been able to perform the pre-processing. The message may also contain a set of parameters which indicate what changes (RRC reconfigurations) UE 110 has made and/or what changes are left to be made after the LTM_switch_command, for example during the operation of LTM config application. At LTM_config_application UE 110 may perform the actions that are left from LTM_evaluation. UE 110 may configure its hardware based on the RRC reconfiguration. UE 110 may apply the delay indicated in the RRC reconfiguration complete message. LTM_config application may also include fully or partially the steps from ASN.1 validation and LTM_evaluation.

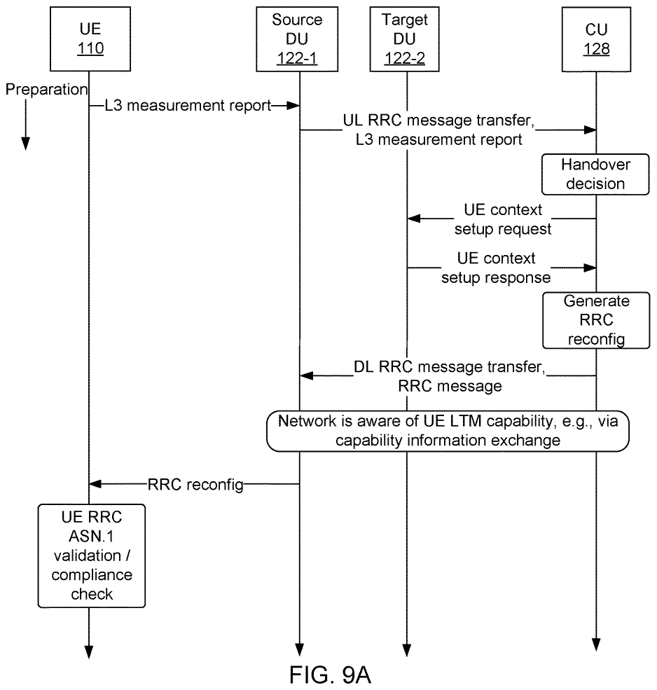

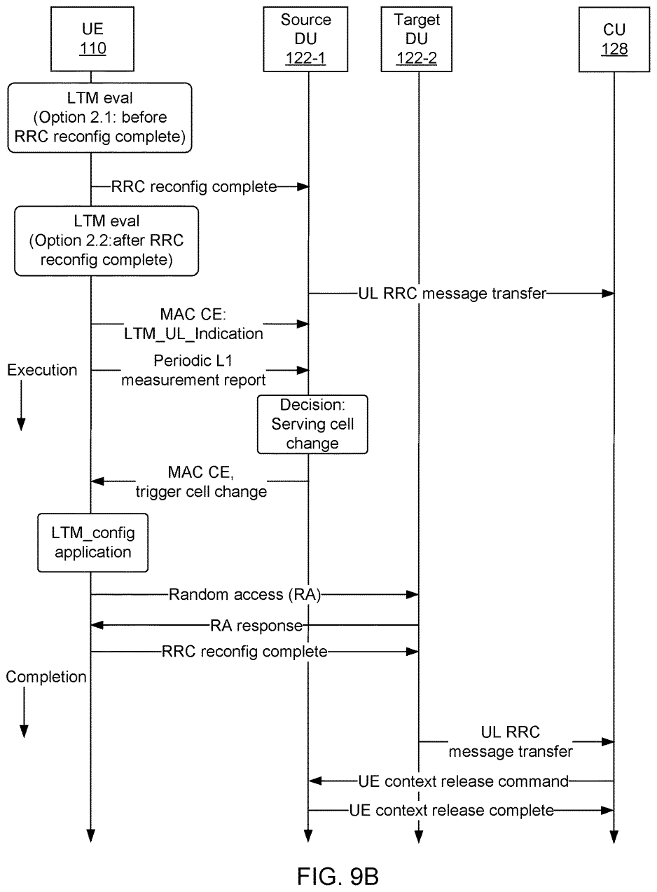

FIGS. 9A and 9B illustrate an example of a message sequence and operations when transmitting an LTM uplink indication in a MAC CE (Option 2). Operations of these figures may be similar to corresponding operation of FIG. 5A, 5B, 8A or 8B with the following remarks. UE 110 may perform LTM evaluation either before (Option 2.1) or after (Option 2.2) transmission of the RRC reconfiguration complete message. UE 110 may transmit the LTM_UL_Indication in a MAC CE (cf. operation 515. UE 110 may indicate that it has processed the RRC configuration via a dedicated MAC CE. UE 110 may also provide information about how long the processing delay is expected to be after the cell switch command. This information may be provided for example as an index to a mapping table that describes the processing values, for example as follows:

| | Processing delay after |
|---|---|
| Index | LTM_switch command |
| 1 | 3 ms |
| 2 | 5 ms |
| 3 | 10 ms |
| 4 | 40 ms |

Source DU 122-1 may apply the new delay profile for UE based on the MAC CE.

At LTM_config_application UE 110 may perform the actions that are left from LTM_evaluation. UE 110 may configure its hardware based on the RRC reconfiguration. UE 110 may apply the delay indicated in the MAC CE. Alternatively the delay can be static, for example specified in a standard. LTM_config application may also include fully or partially the steps from ASN.1. validation and LTM_evaluation.

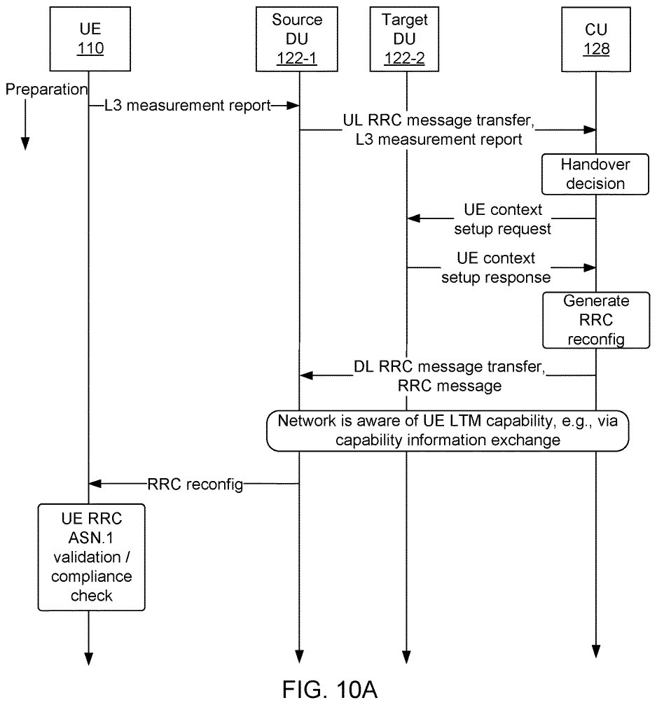

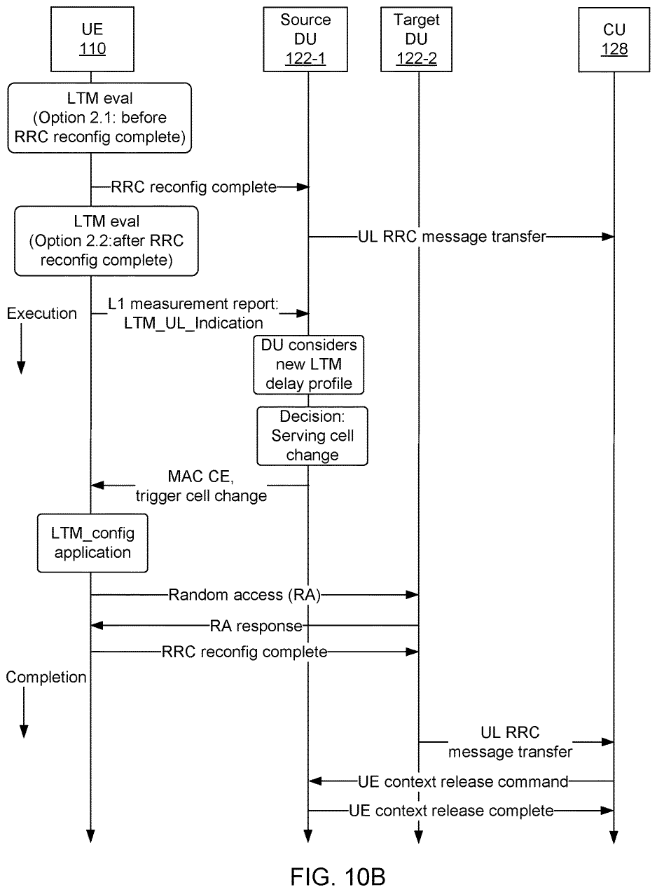

FIGS. 10A and 10B illustrate an example of a message sequence and operations when transmitting an LTM uplink indication in a MAC CE (Option 3). Operations of these figures may be similar to corresponding operation of FIG. 5A, 5B, 8A or 8B with the following remarks. UE 110 may perform LTM evaluation either before (Option 2.1) or after (Option 2.2) transmission of the RRC reconfiguration complete message. UE 110 may transmit the LTM_UL_Indication in a L1 measurement report (cf. operation 516). UE 110 may indicate that it has processed the RRC configuration via the L1 measurement report. UE 110 may also provide information about how long the processing delay is expected to be after the cell switch command. This information may be provided for example as an index to a mapping table that describes the processing values, for example as described with reference to Option above.

Alternatively, the indication via the L1 measurement report may be implicit. For example, UE 110 may transmit the first L1 measurement report. UE 110 may be configured to transmit L1 reports only after it has finalised the LTM_evaluation processing. Based on reception of the (first) L1 measurement report, source DU 122-1 may determine that UE 110 has completed LTM evaluation. For instance, UE 110 may have capability to perform RRC pre-processing. Once network has set a configuration flag in RRC config, the network may assume that UE 110 has performed LTM_evaluation prior to sending L1 measurements.

In response to receiving the LTM_UL indication in the L1 measurement report, source DU 122-1 may consider the new delay profile. For example, source DU 122-1 may apply the new delay profile for UE based on the L1 measurement report.

At LTM_config_application UE 110 may perform the actions that are left from LTM_evaluation. UE 110 may configure its hardware based on the RRC reconfiguration. UE 110 may apply the delay indicated in the L1 measurement report. Alternatively the delay can be static, for example specified in a standard. LTM_config application may also include fully or partially the steps from ASN.1. validation and LTM_evaluation.

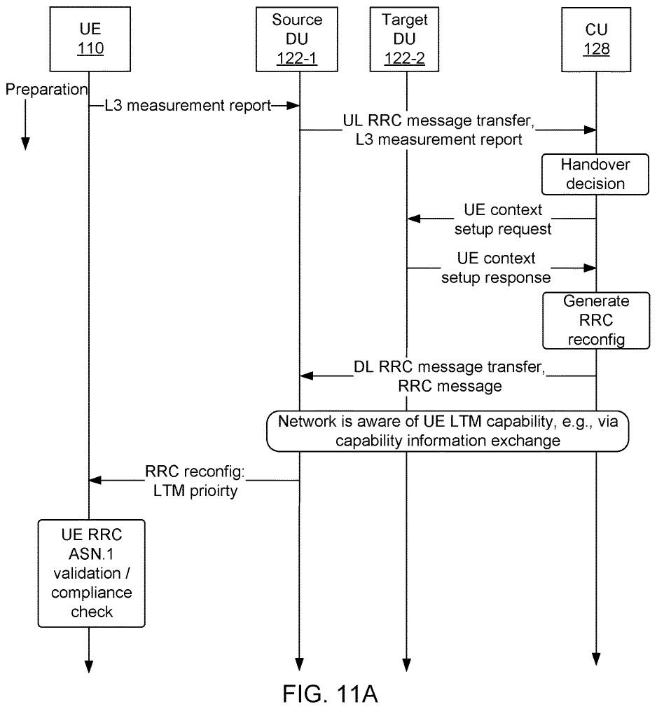

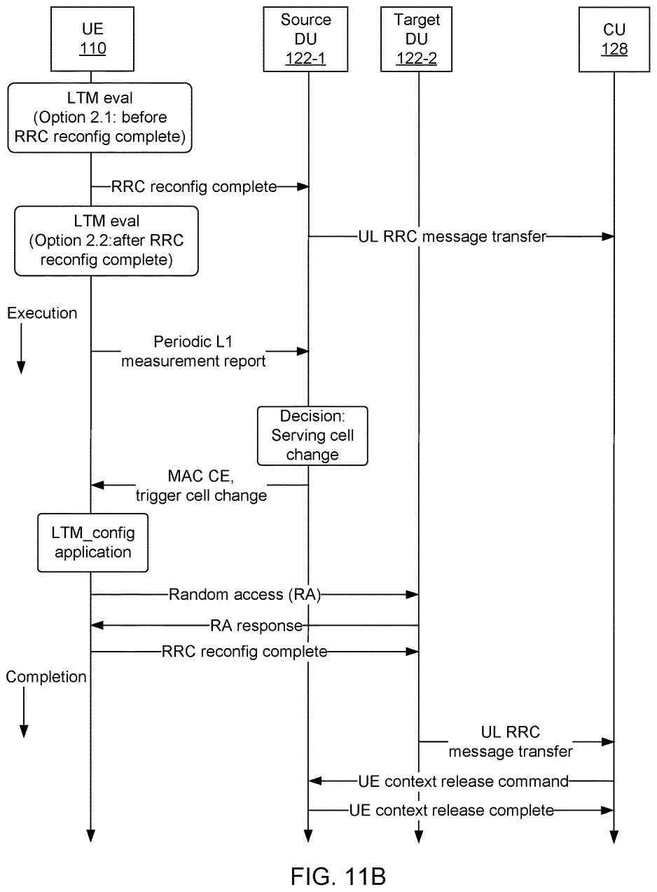

FIGS. 11A and 11B illustrate an example of a message sequence and operations when RRC configuration indicates LTM priority (Option 4). Operations of these figures may be similar to corresponding operation of FIG. 5A, 5B, 8A or 8B with the following remarks.

The RRC reconfiguration transmitted by source DU 122-1 to UE 110 may indicate that UE is requested or commanded to process the received LTM RRC configuration in steps. This may be either before RRC reconfiguration completes, or after RRC reconfiguration completes depending on the complexity of the configuration.

Examples of requirements for LTM are provided below. The requirements may be applicable for example to LTM to change the NR PCell to another NR cell or from NR SCell to another Scell.

NR FRx—NR FRx LTM: These example requirements may be applicable to both intra-frequency and inter-frequency LTM from NR FRx cell to NR FRx cell.

LTM delay: Procedure delays for all procedures that can command a LTM handover are may be specified in a standard. LTM Delay may comprise or consist of LTM preparation delay and LTM execution delay:

$${D}_{LTM} = {D}_{LTM \_ preperation} + {D}_{LTM \_ execution} .$$

When UE 110 receives a RRC message implying LTM handover, UE 110 may perform LTM preparation procedure for LTM. LTM RRC preparation delay may includes an LTM ASN.1 validation delay and LTM RRC Evaluation delay.

$${T}_{RCC \_ preperation \_ delay} = {T}_{ASN \text{.1} \_ validation} + {T}_{RCC \_ LTM \_ evaluation}$$

where:
T_{RRC_preparation_delay} is the delay of RRC pre-processing. This processing contains ASN.1 validation delay and LTM RRC configuration evaluation delay
T_{ASN.1_validation} ASN.1 configuration validation delay
T_{RRC_LTM_evaluation} is the delay it takes for UE to perform LTM configuration evaluation, and extract user plane (MAC/RLC/PDCP/SDAP) and L1 processing indications the RRC LTM command.

LTM execution time T_{LTM_execution} is the UE execution preparation time for LTM, and it may start after UE receives the LTM switch command:

$${T}_{LTM \_ execution} = {T}_{RRC \_ LTM \_ execution \_ intra} + {T}_{LTM \_ switch \_ commmd}$$

where:
T_{RRC_execution} is the UE delay of applying LTM RRC configuration to L1 and L2 as indicated by the RRC command.
T_{LTM_switch_command} is the delay of extracting the target cell information from the switch command and applying

LTM processing requirements are intra- and inter-frequency may be separated.

| | | UE processing |
|---|---|---|
| Delay component | Description | delay |
| T_{LTM}_{_{—}}_{execution}_{_{—}}ᵢₙₜᵣₐ | UE performs T_{LTMexecution}_{_{—}}ᵢₙₜᵣₐ | N ms |
| | processing based on RRC | |
| | evaluation. | |
| T_{LTM}_{_{—}}_{execution}_{_{—}}ᵢₙₜₑᵣ | UE performs T_{LTMexecution}_{_{—}}ᵢₙₜₑᵣ | N ms + M ms |
| | processing based on RRC | |
| | evaluation for inter-frequency | |
| | case. | |

Where N is the maximum LTM execution time for intra-frequency
Where M is the delay from UE inter-frequency configuration processing (applying configuration inter-frequency)
If RRC configuration indicates explicitly L1 and L2 processing components, UE may follow explicit processing delays.

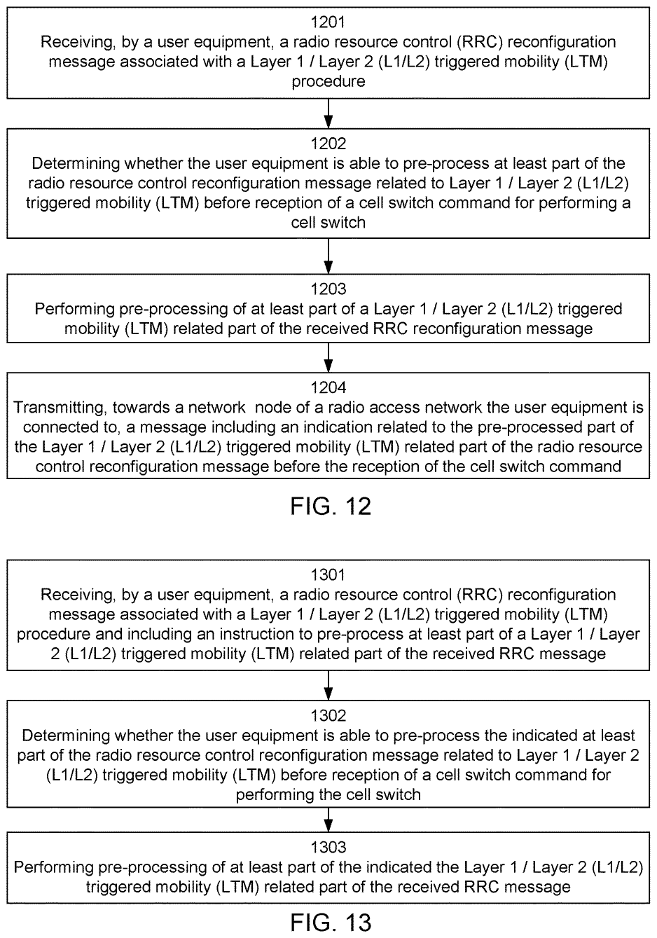

FIG. 12 illustrates an example of a method for indicating ability of pre-processing a RRC reconfiguration before cell switch.

At 1201, the method may comprise receiving, by a user equipment, a radio resource control (RRC) reconfiguration message associated with a Layer 1/Layer 2 (L1/L2) triggered mobility (LTM) procedure.

At 1202, the method may comprise determining whether the user equipment is able to pre-process at least part of the radio resource control reconfiguration message related to Layer 1/Layer 2 (L1/L2) triggered mobility (LTM) before reception of a cell switch command for performing a cell switch.

At 1203, the method may comprise performing pre-processing of at least part of a Layer 1/Layer 2 (L1/L2) triggered mobility (LTM) related part of the received RRC reconfiguration message.

At 1204, the method may comprise transmitting, towards a network node of a radio access network the user equipment is connected to, a message including an indication related to the pre-processed part of the Layer 1/Layer 2 (L1/L2) triggered mobility (LTM) related part of the radio resource control reconfiguration message before the reception of the cell switch command.

FIG. 13 illustrates an example of a method for pre-processing a RRC reconfiguration.

At 1301, the method may comprise receiving, by a user equipment, a radio resource control (RRC) reconfiguration message associated with a Layer 1/Layer 2 (L1/L2) triggered mobility (LTM) procedure and including an instruction to pre-process at least part of a Layer 1/Layer 2 (L1/L2) triggered mobility (LTM) related part of the received RRC message.

At 1302, the method may comprise determining whether the user equipment is able to pre-process the indicated at least part of the radio resource control reconfiguration message related to Layer 1/Layer 2 (L1/L2) triggered mobility (LTM) before reception of a cell switch command for performing the cell switch.

At 1303, the method may comprise performing pre-processing of at least part of the indicated the Layer 1/Layer 2 (L1/L2) triggered mobility (LTM) related part of the received RRC message.

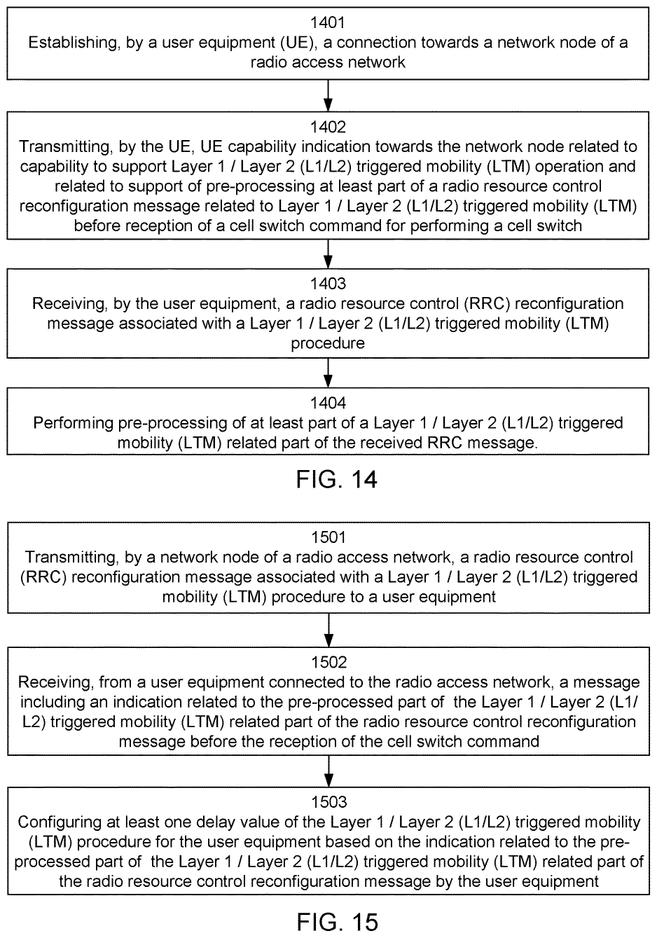

FIG. 14 illustrates an example of a method for indicating a UE capability of pre-processing a RRC reconfiguration before cell switch.

At 1401, the method may comprise establishing, by a user equipment (UE), a connection towards a network node of a radio access network.

At 1402, the method may comprise transmitting, by the UE, UE capability indication towards the network node related to capability to support Layer 1/Layer 2 (L1/L2) triggered mobility (LTM) operation and related to support of pre-processing at least part of a radio resource control reconfiguration message related to Layer 1/Layer 2 (L1/L2) triggered mobility (LTM) before reception of a cell switch command for performing a cell switch.

At 1403, the method may comprise receiving, by the user equipment, a radio resource control (RRC) reconfiguration message associated with a Layer 1/Layer 2 (L1/L2) triggered mobility (LTM) procedure.

At 1404, the method may comprise performing pre-processing of at least part of a Layer 1/Layer 2 (L1/L2) triggered mobility (LTM) related part of the received RRC message.

FIG. 15 illustrates an example of a method for configuring LTM delay(s) based on an indication related to a pre-processed part of LTM related RRC reconfiguration message.

At 1501, the method may comprise transmitting, by a network node of a radio access network, a radio resource control (RRC) reconfiguration message associated with a Layer 1/Layer 2 (L1/L2) triggered mobility (LTM) procedure to a user equipment.

At 1502, the method may comprise receiving, from a user equipment connected to the radio access network, a message including an indication related to the pre-processed part of the Layer 1/Layer 2 (L1/L2) triggered mobility (LTM) related part of the radio resource control reconfiguration message before the reception of the cell switch command.

At 1503, the method may comprise configuring at least one delay value of the Layer 1/Layer 2 (L1/L2) triggered mobility (LTM) procedure for the user equipment based on the indication related to the pre-processed part of the Layer 1/Layer 2 (L1/L2) triggered mobility (LTM) related part of the radio resource control reconfiguration message by the user equipment.

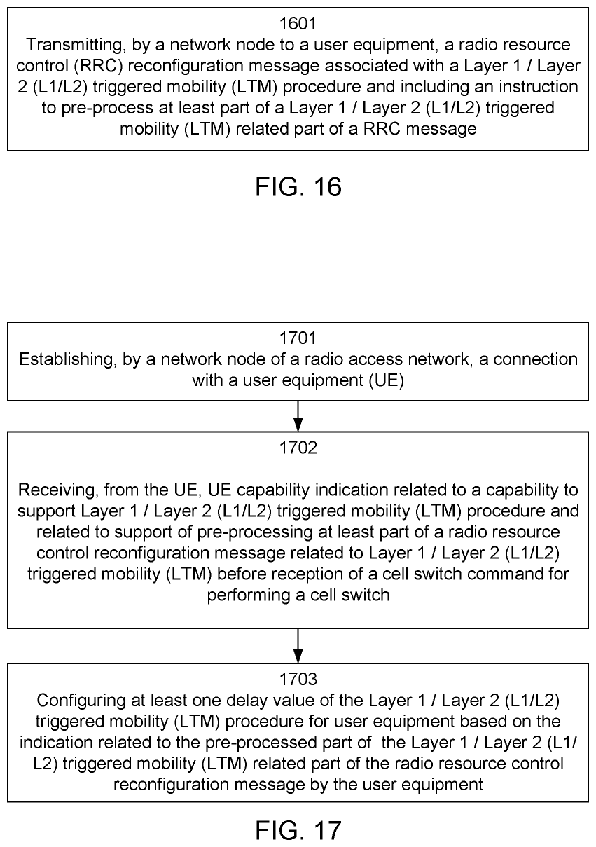

FIG. 16 illustrates a method for instructing a UE to pre-process at least part of LTM related part of a RRC message.

At 1601, the method may comprise transmitting, by a network node to a user equipment, a radio resource control (RRC) reconfiguration message associated with a Layer 1/Layer 2 (L1/L2) triggered mobility (LTM) procedure and including an instruction to pre-process at least part of a Layer 1/Layer 2 (L1/L2) triggered mobility (LTM) related part of a RRC message.

FIG. 17 illustrates a method for configuring LTM delay(s) based on an indication of a UE capability to support LTM pre-processing.

At 1701, the method may comprise establishing, by a network node of a radio access network, a connection with a user equipment (UE).

At 1702, the method may comprise receiving, from the UE, UE capability indication related to a capability to support Layer 1/Layer 2 (L1/L2) triggered mobility (LTM) procedure and related to support of pre-processing at least part of a radio resource control reconfiguration message related to Layer 1/Layer 2 (L1/L2) triggered mobility (LTM) before reception of a cell switch command for performing a cell switch.

At 1703, the method may comprise configuring at least one delay value of the Layer 1/Layer 2 (L1/L2) triggered mobility (LTM) procedure for user equipment based on the indication related to the pre-processed part of the Layer 1/Layer 2 (L1/L2) triggered mobility (LTM) related part of the radio resource control reconfiguration message by the user equipment.

Further features of the methods directly result from the functionality of DU(s) 122-1, 122-2, CU 128, or ULE 110, as described throughout the description, claims, and drawings, and are therefore not repeated here. An apparatus may be configured to perform or cause performance of any aspect of the method(s) described herein. Further, a computer program or a computer program product may comprise instructions for causing, when executed by an apparatus, the apparatus to perform any aspect of the method(s) described herein. Further, an apparatus may comprise means for performing any aspect of the method(s) described herein. According to an example embodiment, the means comprises at least one processor; and at least one memory storing instructions that, when executed by the at least one processor, cause the apparatus at least to perform any aspect of the method(s).

Further examples of methods are provided below:

A method may comprise: receiving, by a user equipment, a radio resource control configuration associated with a handover procedure; determining whether the user equipment is able to process the radio resource control configuration before reception of a cell switch command of the handover procedure; and transmitting, to a source distributed node of the handover procedure, an indication of whether the user equipment is able to process the radio resource control configuration before the reception of the cell switch command.

According to an example embodiment, the handover procedure comprises a layer one or layer two inter-cell mobility procedure, and wherein the radio resource control configuration comprises a layer one or layer two mobility configuration.

According to an example embodiment, the method may comprise: receiving the cell switch command from the source distributed node; and applying the radio resource control configuration, in response to receiving the cell switch command.

According to an example embodiment, the method may comprise: estimating a delay for processing the radio resource control configuration; and transmitting an indication of the estimated delay for processing the radio resource control configuration to the source distributed node.

According to an example embodiment, the method may comprise: receiving the cell change command from the source distributed node; and applying the radio resource control configuration within the estimated delay.

According to an example embodiment, the determining whether the user equipment is able to process the radio resource control configuration before the reception of the cell switch command or the estimation of the delay for processing the radio resource control configuration comprises at least one of the following: determining at least one change required for a medium access control configuration, determining at least one change required for a radio link control configuration, determining at least one change required for a packet data convergence protocol configuration, determining at least one change required for a service data adaptation protocol configuration, determining whether radio frequency retuning is required for complying with the cell switch command, determining whether baseband retuning is required for complying with the cell switch command, or determining whether the user equipment is able to access a target access node unit of the handover procedure without a random access channel procedure.

According to an example embodiment, the method may comprise: transmitting, to the source distributed node, an indication of completion of processing the radio resource control configuration by the user equipment.

According to an example embodiment, the indication of completion of processing the radio resource control configuration is transmitted in a radio resource control reconfiguration complete message, a medium access control control element, a layer one measurement report, or as an indication of a user equipment capability.

According to an example embodiment, the user equipment capability is indicative of at least one of the following: that the user equipment is configured to perform validation of a syntax notation of the radio resource control configuration and the determining whether the user equipment is able to process the radio resource control configuration before the reception of the cell switch command or the estimation of the delay for processing the radio resource control configuration is in response to receiving the radio resource control configuration from the source distributed node, that the user equipment is configured to perform the validation of the syntax notation of the radio resource control configuration in response to receiving the radio resource control configuration from the source distributed node, that the user equipment is configured to process the radio resource control configuration between transmission of a layer one measurement report comprising the indication of whether the user equipment is able to process the radio resource control configuration before the reception of the cell switch command and reception of the cell switch command, that the user equipment is configured to process the radio resource control configuration prior to initiating layer one measurements for the handover procedure, that the user equipment is configured to process the radio resource control configuration after initiating layer one measurements for the handover procedure, or that the user equipment is configured to initiate the determining whether the user equipment is able to process the radio resource control configuration before the reception of the cell switch command or the estimation of the delay for processing the radio resource control configuration, in response to receiving, from the source distributed node, an indication of a target cell of the handover procedure.

According to an example embodiment, the method may comprise: determining whether the user equipment is able to process the radio resource control configuration before the reception of the cell switch command or the estimation of the delay for processing the radio resource control configuration is in response to receiving, from the source distributed node, a request to prioritize validation, processing, or preparation of the radio resource control configuration.

A method may comprise: transmitting, by an access node to a user equipment, a radio resource control configuration associated with the handover procedure; receiving, from the user equipment, an indication of whether the user equipment is able to process the radio resource control configuration before the reception of the cell switch command; and configuring at least one delay value of the handover procedure based on the indication of whether the user equipment is able to process the radio resource control configuration before the reception of the cell switch command; and transmitting a cell switch command of the handover procedure to the user equipment.

According to an example embodiment, the handover procedure comprises a layer one or layer two inter-cell mobility procedure, and wherein the radio resource control configuration comprises a layer one or layer two mobility configuration.

According to an example embodiment, the method may comprise: receiving, from the user equipment, an indication of an estimated delay for processing the radio resource control configuration by the user equipment; and configuring the at least one delay value of the handover procedure based on the estimated delay for processing the radio resource control configuration by the user equipment.

According to an example embodiment, the method may comprise: receiving, from the user equipment, an indication of completion of processing the radio resource control configuration by the user equipment; and configuring the at least one delay value of the handover procedure based on the indication of completion of processing the radio resource control configuration by the user equipment.

According to an example embodiment, the indication of completion of processing the radio resource control configuration is received in a radio resource control reconfiguration complete message, a medium access control control element, a layer one measurement report, or as an indication of a user equipment capability.

According to an example embodiment, the user equipment capability is indicative of at least one of the following: that the user equipment is configured to perform validation of a syntax notation of the radio resource control configuration and the determining whether the user equipment is able to process the radio resource control configuration before the reception of the cell switch command or the estimation of the delay for processing the radio resource control configuration is in response to receiving the radio resource control configuration from a source distributed node of the access node, that the user equipment is configured to perform the validation a syntax notation one of the radio resource control configuration in response to receiving the radio resource control configuration from the source distributed node of the access node, that the user equipment is configured to process the radio resource control configuration between transmission of a layer one measurement report comprising the indication of whether the user equipment is able to process the radio resource control configuration before the reception of the cell switch command and reception of the cell switch command, that the user equipment is configured to process the radio resource control configuration prior to initiating layer one measurements for the handover procedure, that the user equipment is configured to process the radio resource control configuration after initiating layer one measurements for the handover procedure, or that the user equipment is configured to initiate the determining whether the user equipment is able to process the radio resource control configuration before the reception of the cell switch command or the estimation of the delay for processing the radio resource control configuration, in response to receiving, from the source distributed node of the access node, an indication of a target cell of the handover procedure.

According to an example embodiment, the method may comprise: transmitting, to the user equipment, a request to prioritize validation, processing, or preparation of the radio resource control configuration.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

The term ‘comprising’ is used herein to mean including the method, blocks, or elements identified, but that such blocks or elements do not comprise an exclusive list and a method or apparatus may contain additional blocks or elements.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Although subjects may be referred to as ‘first’ or ‘second’ subjects, this does not necessarily indicate any order or importance of the subjects. Instead, such attributes may be used solely for the purpose of making a difference between subjects.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-25. (canceled)

26. A method, comprising:
receiving, by a user equipment, a radio resource control (RRC) reconfiguration message associated with a Layer 1/Layer 2 (L1/L2) triggered mobility (LTM) procedure;
determining whether the user equipment is able to pre-process at least part of the radio resource control reconfiguration message related to Layer 1/Layer 2 (L1/L2) triggered mobility (LTM) before reception of a cell switch command for performing a cell switch;
performing pre-processing of at least part of a Layer 1/Layer 2 (L1/L2) triggered mobility (LTM) related part of the received RRC reconfiguration message; and
transmitting, towards a network node of a radio access network the user equipment is connected to, a message including an indication related to the pre-processed part of the Layer 1/Layer 2 (L1/L2) triggered mobility (LTM) related part of the radio resource control reconfiguration message before the reception of the cell switch command.

27. The method according to claim 26, wherein the network node is a central node of the radio access network and the message transmitted to the central node is an RRC reconfiguration complete message including an LTM indication indicating a status of the pre-processing of LTM preparation operations, in particular an indication whether at least one of Abstract Syntax Notation One (ASN.1) validation and LTM RRC configuration evaluation related operations has been performed.

28. The apparatus according to claim 26, wherein the network node is a distributed node of the radio access network and the message transmitted to the distributed node is a L2 message, in particular a medium access control (MAC) control element (CE) message, including an LTM indication indicating a status of the pre-processing of LTM preparation operations, in particular an indication whether at least one of Abstract Syntax Notation One (ASN.1) validation and LTM RRC configuration evaluation related operations has been performed.

29. The apparatus according to claim 26, wherein the network node is a distributed node of the radio access network and the message transmitted to the distributed node is a L1 measurement report message including an LTM indication indicating a status of the pre-processing of LTM preparation operations, in particular an indication whether at least one of Abstract Syntax Notation One (ASN.1) validation and LTM RRC configuration evaluation related operations has been performed.

30. The method according to claim 26, wherein the indication related to the pre-processed part includes an indication related to a remaining LTM execution time delay.

31. A method, comprising:
receiving, by a user equipment, a radio resource control (RRC) reconfiguration message associated with a Layer 1/Layer 2 (L1/L2) triggered mobility (LTM) procedure and including an instruction to pre-process at least part of a Layer 1/Layer 2 (L1/L2) triggered mobility (LTM) related part of the received RRC message,
determining whether the user equipment is able to pre-process the indicated at least part of the radio resource control reconfiguration message related to Layer 1/Layer 2 (L1/L2) triggered mobility (LTM) before reception of a cell switch command for performing the cell switch, and
performing pre-processing of at least part of the indicated the Layer 1/Layer 2 (L1/L2) triggered mobility (LTM) related part of the received RRC message.

32. The method according to claim 31, further comprising: transmitting, towards a network node of a radio access network the user equipment is connected to, a L1 measurement report message after the performed pre-processing is concluded.

33. The method according to claim 31, further comprising:
in response to receiving a L2 message, in particular a MAC CE message, including the cell switch command, processing a non-pre-processed Layer 1/Layer 2 (L1/L2) triggered mobility (LTM) related part of the received RRC reconfiguration message, and extracting target cell information to switch to from the cell switch command, and performing a random access procedure towards the target cell.

34. A method, comprising:
establishing, by a user equipment (UE), a connection towards a network node of a radio access network;
transmitting, by the UE, UE capability indication towards the network node related to capability to support Layer 1/Layer 2 (L1/L2) triggered mobility (LTM) operation and related to support of pre-processing at least part of a radio resource control reconfiguration message related to Layer 1/Layer 2 (L1/L2) triggered mobility (LTM) before reception of a cell switch command for performing a cell switch;
receiving, by the user equipment, a radio resource control (RRC) reconfiguration message associated with a Layer 1/Layer 2 (L1/L2) triggered mobility (LTM) procedure;
performing pre-processing of at least part of a Layer 1/Layer 2 (L1/L2) triggered mobility (LTM) related part of the received RRC message.

35. The method according to claim 34, wherein the UE capability indication is transmitted to the network node during or after establishment of the connection towards the network node.

36. The method according to claim 35, wherein the UE capability indication is transmitted to the network node before performing preparation for LTM, or, wherein the UE capability indication is transmitted to the network node before or together with a L3 measurement report.

37. The method according to claim 34, wherein the pre-processing of the at least part of the Layer 1/Layer 2 (L1/L2) triggered mobility (LTM) related part of the received RRC reconfiguration message comprises pre-processing at least one of Abstract Syntax Notation One (ASN.1) validation and LTM RRC configuration evaluation related operations.

38. A user equipment, UE, comprising:
at least one processor; and
at least one memory storing instructions that, when executed by the at least one processor, cause the UE at least to:
receive, by a user equipment, a radio resource control (RRC) reconfiguration message associated with a Layer 1/Layer 2 (L1/L2) triggered mobility (LTM) procedure;
determine whether the user equipment is able to pre-process at least part of the radio resource control reconfiguration message related to Layer 1/Layer 2 (L1/L2) triggered mobility (LTM) before reception of a cell switch command for performing a cell switch;
perform pre-processing of at least part of a Layer 1/Layer 2 (L1/L2) triggered mobility (LTM) related part of the received RRC reconfiguration message; and
transmit, towards a network node of a radio access network the user equipment is connected to, a message including an indication related to the pre-processed part of the Layer 1/Layer 2 (L1/L2) triggered mobility (LTM) related part of the radio resource control reconfiguration message before the reception of the cell switch command.

39. A user equipment, UE, comprising:
at least one processor; and
at least one memory storing instructions that, when executed by the at least one processor, cause the UE at least to:
establish, by a user equipment (UE), a connection towards a network node of a radio access network;
transmit, by the UE, UE capability indication towards the network node related to capability to support Layer 1/Layer 2 (L1/L2) triggered mobility (LTM) operation and related to support of pre-processing at least part of a radio resource control reconfiguration message related to Layer 1/Layer 2 (L1/L2) triggered mobility (LTM) before reception of a cell switch command for performing a cell switch;
receive, by the user equipment, a radio resource control (RRC) reconfiguration message associated with a Layer 1/Layer 2 (L1/L2) triggered mobility (LTM) procedure;
perform pre-processing of at least part of a Layer 1/Layer 2 (L1/L2) triggered mobility (LTM) related part of the received RRC message.

40. The UE according to claim 39, wherein the UE capability indication is transmitted to the network node during or after establishment of the connection towards the network node.

41. The UE according to claim 40, wherein the UE capability indication is transmitted to the network node before performing preparation for LTM, or, wherein the UE capability indication is transmitted to the network node before or together with a L3 measurement report.

42. The UE according to claim 39, wherein the pre-processing of the at least part of the Layer 1/Layer 2 (L1/L2) triggered mobility (LTM) related part of the received RRC reconfiguration message comprises pre-processing at least one of Abstract Syntax Notation One (ASN.1) validation and LTM RRC configuration evaluation related operations.
